(19) United States
(12) Patent Application Publication
(10) Pub. No.: US 2013/0343459 A1
(43) Pub. Date: Dec. 26, 2013

(54) METHOD AND APPARATUS FOR VIDEO CODING

(71) Applicants: Mehmet Oguz Bici, Tampere (FI); Kemal Ugur, Istanbul (TR); Miska Matias Hannuksela, Tampere (FI)

(72) Inventors: Mehmet Oguz Bici, Tampere (FI); Kemal Ugur, Istanbul (TR); Miska Matias Hannuksela, Tampere (FI)

(73) Assignee: NOKIA CORPORATION, Espoo (FI)

(21) Appl. No.: 13/919,094

(22) Filed: Jun. 17, 2013

Related U.S. Application Data
(60) Provisional application No. 61/663,193, filed on Jun. 22, 2012.

(51) Int. Cl. H04N 7/36

(52) U.S. Cl. CPC H04N 19/00684
USPC 375/240.16

(57) ABSTRACT

There is provided a method, apparatus and computer program product. In some embodiments an uncompressed picture is encoded into a coded picture comprising a slice; determining a list of prediction reference candidates for the slice in one or more temporal reference pictures; associating each prediction reference candidate in the list with a reference index; and examining if the prediction reference candidate associated with a first reference index is available for temporal motion vector prediction for the slice. If the prediction reference candidate with the first reference index is not available for temporal motion vector prediction for the slice, examining if the list comprises another prediction reference candidate associated with another reference index. If the list comprises another prediction reference candidate associated with another reference index, providing the reference index associated with the another prediction reference candidate in a syntax element at a slice level or at a higher level.

### TECHNICAL FIELD

The present application relates generally to an apparatus, a method and a computer program for video coding and decoding.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

A video coding system may comprise an encoder that transforms an input video into a compressed representation suited for storage/transmission and a decoder that can uncompress the compressed video representation back into a viewable form. The encoder may discard some information in the original video sequence in order to represent the video in a more compact form, for example, to enable the storage/transmission of the video information at a lower bitrate than otherwise might be needed.

Various technologies for providing three-dimensional (3D) video content are currently investigated and developed. Especially, intense studies have been focused on various multiview applications wherein a viewer is able to see only one pair of stereo video from a specific viewpoint and another pair of stereo video from a different viewpoint. One of the most feasible approaches for such multiview applications has turned out to be such wherein only a limited number of input views, e.g. a mono or a stereo video plus some supplementary data, is provided to a decoder side and all required views are then rendered (i.e. synthesized) locally by the decoder to be displayed on a display.

Some video coding standards introduce headers at slice layer and below, and a concept of a parameter set at layers above the slice layer. An instance of a parameter set may include all picture, group of pictures (GOP), and sequence level data such as picture size, display window, optional coding modes employed, macroblock allocation map, and others. Each parameter set instance may include a unique identifier. Each slice header may include a reference to a parameter set identifier, and the parameter values of the referred parameter set may be used when decoding the slice. Parameter sets decouple the transmission and decoding order of infrequently changing picture, GOP, and sequence level data from sequence, GOP, and picture boundaries. Parameter sets can be transmitted out-of-band using a reliable transmission protocol as long as they are decoded before they are referred. If parameter sets are transmitted in-band, they can be repeated multiple times to improve error resilience compared to conventional video coding schemes. The parameter sets may be transmitted at a session set-up time. However, in some systems, mainly broadcast ones, reliable out-of-band transmission of parameter sets may not be feasible, but rather parameter sets are conveyed in-band in Parameter Set NAL units.

### SUMMARY

According to some example embodiments of the present invention there is provided a method, apparatus and computer program product for providing a reference index of a temporal motion vector predictor in a merge mode. The reference index may be explicitly signaled for example in a slice header.

In this way, it is possible to utilize temporal motion vector prediction even if the picture at reference index equal to 0 would avoid derivation of temporal motion vector prediction.

Various aspects of examples of the invention are set out in the claims.

According to a first aspect of the present invention, there is provided a method comprising:

determining a list of prediction reference candidates for a slice of a picture in one or more reference pictures;

associating each prediction reference candidate in the list with a reference index;

selecting a prediction reference candidate for motion vector prediction;

providing the reference index associated with the selected prediction reference candidate in a syntax element at a slice level or at a higher level.

According to a second aspect of the present invention, there is provided a method comprising:

determining a list of prediction reference candidates for a slice of a picture in one or more reference pictures;

associating each prediction reference candidate in the list with a reference index;

selecting one of the prediction reference candidates as a prediction reference in encoding the picture by examining the prediction reference candidates.

According to a third aspect of the present invention, there is provided an apparatus comprising at least one processor and at least one memory including computer program code, the at least one memory and the computer program code configured to, with the at least one processor, cause the apparatus to:

determine a list of prediction reference candidates for a slice of a picture in one or more reference pictures;

associate each prediction reference candidate in the list with a reference index;

select a prediction reference candidate associated with a reference index for motion vector prediction;

provide the reference index associated with the prediction reference candidate in a syntax element at a slice level or at a higher level.

According to a fourth aspect of the present invention, there is provided an apparatus comprising at least one processor and at least one memory including computer program code, the at least one memory and the computer program code configured to, with the at least one processor, cause the apparatus to:

determine a list of prediction reference candidates for a slice of a picture in one or more reference pictures;

associate each prediction reference candidate in the list with a reference index;

select one of the prediction reference candidates as a prediction reference in encoding the picture by examining the prediction reference candidates.

According to a fifth aspect of the present invention, there is provided a computer program product including one or more sequences of one or more instructions which, when executed by one or more processors, cause an apparatus to at least perform the following:

determine a list of prediction reference candidates for a slice of a picture in one or more reference pictures;

associate each prediction reference candidate in the list with a reference index;

select a prediction reference candidate associated with a reference index for motion vector prediction;

provide the reference index associated with the prediction reference candidate in a syntax element at a slice level or at a higher level.

According to a sixth aspect of the present invention, there is provided a computer program product including one or more sequences of one or more instructions which, when executed by one or more processors, cause an apparatus to at least perform the following:

determine a list of prediction reference candidates for a slice of a picture in one or more reference pictures;

associate each prediction reference candidate in the list with a reference index;

select one of the prediction reference candidates as a prediction reference in encoding the picture by examining the prediction reference candidates.

According to a seventh aspect of the present invention, there is provided an apparatus comprising:

means for determining a list of prediction reference candidates for a slice of a picture in one or more reference pictures;

means for associating each prediction reference candidate in the list with a reference index;

means for selecting a prediction reference candidate for motion vector prediction;

means for providing the reference index associated with the selected prediction reference candidate in a syntax element at a slice level or at a higher level.

According to an eighth aspect of the present invention, there is provided an apparatus comprising:

means for determining a list of prediction reference candidates for a slice of a picture in one or more reference pictures;

means for associating each prediction reference candidate in the list with a reference index;

means for selecting one of the prediction reference candidates as a prediction reference in encoding the picture by examining the prediction reference candidates.

According to a ninth aspect of the present invention, there is provided a method comprising:

determining a list of prediction reference candidates for a slice of a picture in one or more reference pictures;

associating each prediction reference candidate in the list with a reference index;

receiving a syntax element including a reference index indicative of a prediction reference candidate used for motion vector prediction in encoding;

using the reference index to select the prediction reference for decoding the slice.

According to a tenth aspect of the present invention, there is provided a method comprising:

determining a list of prediction reference candidates for a slice of a picture in one or more reference pictures;

associating each prediction reference candidate in the list with a reference index;

selecting one of the prediction reference candidates as a prediction reference in decoding the picture by examining the prediction reference candidates.

According to an eleventh aspect of the present invention, there is provided an apparatus comprising at least one processor and at least one memory including computer program code, the at least one memory and the computer program code configured to, with the at least one processor, cause the apparatus to:

determine a list of prediction reference candidates for a slice of a picture in one or more reference pictures;

associate each prediction reference candidate in the list with a reference index;

receive a syntax element including a reference index indicative of a prediction reference candidate used for motion vector prediction in encoding;

use the reference index to select the prediction reference for decoding the slice.

According to a twelfth aspect of the present invention, there is provided an apparatus comprising at least one processor and at least one memory including computer program code, the at least one memory and the computer program code configured to, with the at least one processor, cause the apparatus to:

determine a list of prediction reference candidates for a slice of a picture in one or more reference pictures;

associate each prediction reference candidate in the list with a reference index;

select one of the prediction reference candidates as a prediction reference in decoding the picture by examining the prediction reference candidates.

According to a thirteenth aspect of the present invention, there is provided a computer program product including one or more sequences of one or more instructions which, when executed by one or more processors, cause an apparatus to at least perform the following:

determine a list of prediction reference candidates for a slice of a picture in one or more reference pictures;

associate each prediction reference candidate in the list with a reference index;

receive a syntax element including a reference index indicative of a prediction reference candidate used for motion vector prediction in encoding;

use the reference index to select the prediction reference for decoding the slice.

According to a fourteenth aspect of the present invention, there is provided a computer program product including one or more sequences of one or more instructions which, when executed by one or more processors, cause an apparatus to at least perform the following:

determine a list of prediction reference candidates for a slice of a picture in one or more reference pictures;

associate each prediction reference candidate in the list with a reference index;

select one of the prediction reference candidates as a prediction reference in decoding the picture by examining the prediction reference candidates.

According to a fifteenth aspect of the present invention, there is provided an apparatus comprising:

means for determining a list of prediction reference candidates for a slice of a picture in one or more reference pictures;

means for associating each prediction reference candidate in the list with a reference index;

means for receiving a syntax element including a reference index indicative of a prediction reference candidate used for motion vector prediction in decoding;

means for using the reference index to select the prediction reference for decoding the slice.

According to a sixteenth aspect of the present invention, there is provided an apparatus comprising:

means for determining a list of prediction reference candidates for a slice of a picture in one or more reference pictures;

means for associating each prediction reference candidate in the list with a reference index;

means for selecting one of the prediction reference candidates as a prediction reference in decoding the picture by examining the prediction reference candidates.

### BRIEF DESCRIPTION OF THE DRAWINGS

For a more complete understanding of example embodiments of the present invention, reference is now made to the following descriptions taken in connection with the accompanying drawings in which:

FIG. 1 shows a block diagram of a video coding system according to an example embodiment;

FIG. 2 shows an apparatus for video coding according to an example embodiment;

FIG. 3 shows an arrangement for video coding comprising a plurality of apparatuses, networks and network elements according to an example embodiment; and

FIG. 4a shows schematically an embodiment of the invention as incorporated within an encoder;

FIG. 4b shows schematically an embodiment of a prediction reference list generation and modification according to some embodiments of the invention;

FIG. 5a shows a high level flow chart of an embodiment of a method of selecting a reference index in a merge mode;

FIG. 5b shows a high level flow chart of an embodiment of a method of encoding a selected reference index in the merge mode;

FIG. 6a illustrates an example of spatial and temporal prediction of a prediction unit;

FIG. 6b illustrates another example of spatial and temporal prediction of a prediction unit;

FIG. 7 shows schematically an embodiment of the invention as incorporated within a decoder; and

FIG. 8 illustrates an example of a coding unit and some neighbour blocks of the coding unit; and

FIG. 9 shows a high level flow chart of an embodiment of a method of receiving by a decoder a reference index in the merge mode.

### DETAILED DESCRIPTION OF SOME EXAMPLE EMBODIMENTS

In the following, several embodiments of the invention will be described in the context of one video coding arrangement. It is to be noted, however, that the invention is not limited to this particular arrangement. In fact, the different embodiments have applications widely in any environment where improvement of reference picture handling is required. For example, the invention may be applicable to video coding systems like streaming systems, DVD players, digital television receivers, personal video recorders, systems and computer programs on personal computers, handheld computers and communication devices, as well as network elements such as transcoders and cloud computing arrangements where video data is handled.

The H.264/AVC standard was developed by the Joint Video Team (JVT) of the Video Coding Experts Group (VCEG) of the Telecommunications Standardization Sector of International Telecommunication Union (ITU-T) and the Moving Picture Experts Group (MPEG) of International Organisation for Standardization (ISO)/International Electrotechnical Commission (IEC). The H.264/AVC standard is published by both parent standardization organizations, and it is referred to as ITU-T Recommendation H.264 and ISO/IEC International Standard 14496-10, also known as MPEG-4 Part 10 Advanced Video Coding (AVC). There have been multiple versions of the H.264/AVC standard, each integrating new extensions or features to the specification. These extensions include Scalable Video Coding (SVC) and Multiview Video Coding (MVC).

A scalable video codec for quality scalability (also known as Signal-to-Noise or SNR) and/or spatial scalability may be implemented as follows. For a base layer, a conventional non-scalable video encoder and decoder is used. The reconstructed/decoded pictures of the base layer are included in the reference picture buffer for an enhancement layer. In H.264/AVC, HEVC, and similar codecs using reference picture list(s) for inter prediction, the base layer decoded pictures may be inserted into a reference picture list(s) for coding/decoding of an enhancement layer picture similarly to the decoded reference pictures of the enhancement layer. Consequently, the encoder may choose a base-layer reference picture as inter prediction reference and may indicate its use e.g. with a reference picture index in the coded bitstream. The decoder decodes from the bitstream, for example from a reference picture index, that a base-layer picture is used as an inter prediction reference for the enhancement layer. When a decoded base-layer picture is used as a prediction reference for an enhancement layer, it is referred to as an inter-layer reference picture.

MVC and various other technologies for providing three-dimensional (3D) video content are currently investigated and developed. Especially, intense studies have been focused on various multiview applications wherein a viewer is able to see only one pair of stereo video from a specific viewpoint and another pair of stereo video from a different viewpoint. One of the most feasible approaches for such multiview applications has turned out to be such wherein only a limited number of input views, e.g. a mono or a stereo video plus some supplementary data, is provided to a decoder side and all required views are then rendered (i.e. synthesized) locally by the decoder to be displayed on a display.

Some key definitions, bitstream and coding structures, and concepts of H.264/AVC and HEVC are described in this section as an example of a video encoder, decoder, encoding method, decoding method, and a bitstream structure, wherein the embodiments may be implemented. Some of the key definitions, bitstream and coding structures, and concepts of H.264/AVC are the same as in the current working draft of HEVC—hence, they are described below jointly. The aspects of the invention are not limited to H.264/AVC or HEVC, but rather the description is given for one possible basis on top of which the invention may be partly or fully realized.

Similarly to many earlier video coding standards, the bitstream syntax and semantics as well as the decoding process for error-free bitstreams are specified in H.264/AVC and HEVC. The encoding process is not specified, but encoders must generate conforming bitstreams. Bitstream and decoder conformance can be verified with the Hypothetical Reference Decoder (HRD). The standards contain coding tools that help in coping with transmission errors and losses, but the use of the tools in encoding is optional and no decoding process has been specified for erroneous bitstreams.

The elementary unit for the input to an H.264/AVC or HEVC encoder and the output of an H.264/AVC or HEVC decoder, respectively, is a picture. In H.264/AVC, a picture may either be a frame or a field. In the current working draft of HEVC, a picture is a frame. A frame comprises a matrix of luma samples and corresponding chroma samples. A field is a set of alternate sample rows of a frame and may be used as encoder input, when the source signal is interlaced. Chroma pictures may be subsampled when compared to luma pictures. For example, in the 4:2:0 sampling pattern the spatial resolution of chroma pictures is half of that of the luma picture along both coordinate axes.

In H.264/AVC, a macroblock is a 16×16 block of luma samples and the corresponding blocks of chroma samples. For example, in the 4:2:0 sampling pattern, a macroblock contains one 8×8 block of chroma samples per each chroma component. In H.264/AVC, a picture is partitioned to one or more slice groups, and a slice group contains one or more slices. In H.264/AVC, a slice consists of an integer number of macroblocks ordered consecutively in the raster scan within a particular slice group.

In a draft HEVC standard, video pictures are divided into coding units (CU) covering the area of the picture. A CU consists of one or more prediction units (PU) defining the prediction process for the samples within the CU and one or more transform units (TU) defining the prediction error coding process for the samples in the CU. Typically, a CU consists of a square block of samples with a size selectable from a predefined set of possible CU sizes. A CU with the maximum allowed size is typically named as CTU (coding tree unit) and the video picture is divided into non-overlapping CTUs. An CTU can be further split into a combination of smaller CUs, e.g. by recursively splitting the CTU and resultant CUs. Each resulting CU typically has at least one PU and at least one TU associated with it. Each PU and TU can further be split into smaller PUs and TUs in order to increase granularity of the prediction and prediction error coding processes, respectively. The PU splitting can be realized by splitting the CU into four equal size square PUs or splitting the CU into two rectangle PUs vertically or horizontally in a symmetric or asymmetric way. The division of the image into CUs, and division of CUs into PUs and TUs is typically signalled in the bitstream allowing the decoder to reproduce the intended structure of these units.

In a draft HEVC standard, a picture can be partitioned in tiles, which are rectangular and contain an integer number of CTUs. In the current working draft of HEVC, the partitioning to tiles forms a regular grid, where heights and widths of tiles differ from each other by one CTU at the maximum. In a draft HEVC, a slice consists of an integer number of CUs. The CUs are scanned in the raster scan order of CTUs within tiles or within a picture, if tiles are not in use. Within an CTU, the CUs have a specific scan order.

In a Working Draft (WD) 5 of HEVC, some key definitions and concepts for picture partitioning are defined as follows. A partitioning is defined as the division of a set into subsets such that each element of the set is in exactly one of the subsets.

A basic coding unit in a HEVC WD5 is a treeblock. A treeblock is an N×N block of luma samples and two corresponding blocks of chroma samples of a picture that has three sample arrays, or an N×N block of samples of a monochrome picture or a picture that is coded using three separate colour planes. A treeblock may be partitioned for different coding and decoding processes. A treeblock partition is a block of luma samples and two corresponding blocks of chroma samples resulting from a partitioning of a treeblock for a picture that has three sample arrays or a block of luma samples resulting from a partitioning of a treeblock for a monochrome picture or a picture that is coded using three separate colour planes. Each treeblock is assigned a partition signalling to identify the block sizes for intra or inter prediction and for transform coding. The partitioning is a recursive quadtree partitioning. The root of the quadtree is associated with the treeblock. The quadtree is split until a leaf is reached, which is referred to as the coding node. The coding node is the root node of two trees, the prediction tree and the transform tree. The prediction tree specifies the position and size of prediction blocks. The prediction tree and associated prediction data are referred to as a prediction unit. The transform tree specifies the position and size of transform blocks. The transform tree and associated transform data are referred to as a transform unit. The splitting information for luma and chroma is identical for the prediction tree and may or may not be identical for the transform tree. The coding node and the associated prediction and transform units form together a coding unit.

In a HEVC WD5, pictures are divided into slices and tiles. A slice may be a sequence of treeblocks but (when referring to a so-called fine granular slice) may also have its boundary within a treeblock at a location where a transform unit and prediction unit coincide. Treeblocks within a slice are coded and decoded in a raster scan order. For the primary coded picture, the division of each picture into slices is a partitioning.

In a HEVC WD5, a tile is defined as an integer number of treeblocks co-occurring in one column and one row, ordered consecutively in the raster scan within the tile. For the primary coded picture, the division of each picture into tiles is a partitioning. Tiles are ordered consecutively in the raster scan within the picture. Although a slice contains treeblocks that are consecutive in the raster scan within a tile, these treeblocks are not necessarily consecutive in the raster scan within the picture. Slices and tiles need not contain the same sequence of treeblocks. A tile may comprise treeblocks contained in more than one slice. Similarly, a slice may comprise treeblocks contained in several tiles.

In H.264/AVC and HEVC, in-picture prediction may be disabled across slice boundaries. Thus, slices can be regarded as a way to split a coded picture into independently decodable pieces, and slices are therefore often regarded as elementary units for transmission. In many cases, encoders may indicate in the bitstream which types of in-picture prediction are turned off across slice boundaries, and the decoder operation takes this information into account for example when concluding which prediction sources are available. For example, samples from a neighboring macroblock or CU may be regarded as unavailable for intra prediction, if the neighboring macroblock or CU resides in a different slice.

A syntax element may be defined as an element of data represented in the bitstream. A syntax structure may be defined as zero or more syntax elements present together in the bitstream in a specified order.

The elementary unit for the output of an H.264/AVC or HEVC encoder and the input of an H.264/AVC or HEVC decoder, respectively, is a Network Abstraction Layer (NAL) unit. For transport over packet-oriented networks or storage into structured files, NAL units may be encapsulated into packets or similar structures. A bytestream format has been specified in H.264/AVC and HEVC for transmission or storage environments that do not provide framing structures. The bytestream format separates NAL units from each other by attaching a start code in front of each NAL unit. To avoid false detection of NAL unit boundaries, encoders may run a byte-oriented start code emulation prevention algorithm, which adds an emulation prevention byte to the NAL unit payload if a start code would have occurred otherwise. In order to enable straightforward gateway operation between packet- and stream-oriented systems, start code emulation prevention may always be performed regardless of whether the bytestream format is in use or not.

NAL units consist of a header and payload. In H.264/AVC and HEVC, the NAL unit header indicates the type of the NAL unit and whether a coded slice contained in the NAL unit is a part of a reference picture or a non-reference picture. H.264/AVC includes a 2-bit nal_ref_idc syntax element, which when equal to 0 indicates that a coded slice contained in the NAL unit is a part of a non-reference picture and when greater than 0 indicates that a coded slice contained in the NAL unit is a part of a reference picture. A draft HEVC includes a 1-bit nal_ref_idc syntax element, also known as nal_ref_flag, which when equal to 0 indicates that a coded slice contained in the NAL unit is a part of a non-reference picture and when equal to 1 indicates that a coded slice contained in the NAL unit is a part of a reference picture. The header for SVC and MVC NAL units may additionally contain various indications related to the scalability and multiview hierarchy. In HEVC, the NAL unit header includes the temporal_id syntax element, which specifies a temporal identifier for the NAL unit. The bitstream created by excluding all VCL NAL units having a temporal_id greater than or equal to a selected value and including all other VCL NAL units remains conforming. Consequently, a picture having temporal_id equal to TID does not use any picture having a temporal_id greater than TID as inter prediction reference. In a draft HEVC, the reference picture list initialization is limited to only reference picture marked as “used for reference” and having a temporal_id less than or equal to the temporal_id of the current picture.

NAL units can be categorized into Video Coding Layer (VCL) NAL units and non-VCL NAL units. VCL NAL units are typically coded slice NAL units. In H.264/AVC, coded slice NAL units contain syntax elements representing one or more coded macroblocks, each of which corresponds to a block of samples in the uncompressed picture. In HEVC, coded slice NAL units contain syntax elements representing one or more CU. In H.264/AVC and HEVC a coded slice NAL unit can be indicated to be a coded slice in an Instantaneous Decoding Refresh (IDR) picture or coded slice in a non-IDR picture. In HEVC, a coded slice NAL unit can be indicated to be a coded slice in a Clean Decoding Refresh (CDR) picture (which may also be referred to as a Clean Random Access picture).

A non-VCL NAL unit may be for example one of the following types: a sequence parameter set, a picture parameter set, a supplemental enhancement information (SEI) NAL unit, an access unit delimiter, an end of sequence NAL unit, an end of stream NAL unit, or a filler data NAL unit. Parameter sets may be needed for the reconstruction of decoded pictures, whereas many of the other non-VCL NAL units are not necessary for the reconstruction of decoded sample values.

Parameters that remain unchanged through a coded video sequence may be included in a sequence parameter set (SPS). In addition to the parameters that may be essential to the decoding process, the sequence parameter set may optionally contain video usability information (VUI), which includes parameters that may be important for buffering, picture output timing, rendering, and resource reservation. There are three NAL units specified in H.264/AVC to carry sequence parameter sets: the sequence parameter set NAL unit containing all the data for H.264/AVC VCL NAL units in the sequence, the sequence parameter set extension NAL unit containing the data for auxiliary coded pictures, and the subset sequence parameter set for MVC and SVC VCL NAL units. A picture parameter set (PPS) contains such parameters that are likely to be unchanged in several coded pictures.

In a draft HEVC, there is also a third type of parameter sets, here referred to as Adaptation Parameter Set (APS), which includes parameters that are likely to be unchanged in several coded slices. In a draft HEVC, the APS syntax structure includes parameters or syntax elements related to context-based adaptive binary arithmetic coding (CABAC), adaptive sample offset, adaptive loop filtering, and deblocking filtering. In a draft HEVC, an APS is a NAL unit and coded without reference or prediction from any other NAL unit. An identifier, referred to as aps_id syntax element, is included in APS NAL unit, and included and used in the slice header to refer to a particular APS.

H.264/AVC and HEVC syntax allows many instances of parameter sets, and each instance is identified with a unique identifier. In H.264/AVC, each slice header includes the identifier of the picture parameter set that is active for the decoding of the picture that contains the slice, and each picture parameter set contains the identifier of the active sequence parameter set. Consequently, the transmission of picture and sequence parameter sets does not have to be accurately synchronized with the transmission of slices. Instead, it is sufficient that the active sequence and picture parameter sets are received at any moment before they are referenced, which allows transmission of parameter sets “out-of-band” using a more reliable transmission mechanism compared to the protocols used for the slice data. For example, parameter sets can be included as a parameter in the session description for Real-time Transport Protocol (RTP) sessions. If parameter sets are transmitted in-band, they can be repeated to improve error robustness.

A SEI NAL unit may contain one or more SEI messages, which are not required for the decoding of output pictures but assist in related processes, such as picture output timing, rendering, error detection, error concealment, and resource reservation. Several SEI messages are specified in H.264/AVC and HEVC, and the user data SEI messages enable organizations and companies to specify SEI messages for their own use. H.264/AVC and HEVC contain the syntax and semantics for the specified SEI messages but no process for handling the messages in the recipient is defined. Consequently, encoders are required to follow the H.264/AVC standard or the HEVC standard when they create SEI messages, and decoders conforming to the H.264/AVC standard or the HEVC standard, respectively, are not required to process SEI messages for output order conformance. One of the reasons to include the syntax and semantics of SEI messages in H.264/AVC and HEVC is to allow different system specifications to interpret the supplemental information identically and hence interoperate. It is intended that system specifications can require the use of particular SEI messages both in the encoding end and in the decoding end, and additionally the process for handling particular SEI messages in the recipient can be specified.

A coded picture is a coded representation of a picture. A coded picture in H.264/AVC comprises the VCL NAL units that are required for the decoding of the picture. In H.264/AVC, a coded picture can be a primary coded picture or a redundant coded picture. A primary coded picture is used in the decoding process of valid bitstreams, whereas a redundant coded picture is a redundant representation that should only be decoded when the primary coded picture cannot be successfully decoded. In a draft HEVC, no redundant coded picture has been specified.

In H.264/AVC and HEVC, an access unit comprises a primary coded picture and those NAL units that are associated with it. In H.264/AVC, the appearance order of NAL units within an access unit is constrained as follows. An optional access unit delimiter NAL unit may indicate the start of an access unit. It is followed by zero or more SEI NAL units. The coded slices of the primary coded picture appear next. In H.264/AVC, the coded slice of the primary coded picture may be followed by coded slices for zero or more redundant coded pictures. A redundant coded picture is a coded representation of a picture or a part of a picture. A redundant coded picture may be decoded if the primary coded picture is not received by the decoder for example due to a loss in transmission or a corruption in physical storage medium.

In H.264/AVC, an access unit may also include an auxiliary coded picture, which is a picture that supplements the primary coded picture and may be used for example in the display process. An auxiliary coded picture may for example be used as an alpha channel or alpha plane specifying the transparency level of the samples in the decoded pictures. An alpha channel or plane may be used in a layered composition or rendering system, where the output picture is formed by overlaying pictures being at least partly transparent on top of each other. An auxiliary coded picture has the same syntactic and semantic restrictions as a monochrome redundant coded picture. In H.264/AVC, an auxiliary coded picture contains the same number of macroblocks as the primary coded picture.

A coded video sequence is defined to be a sequence of consecutive access units in decoding order from an IDR access unit, inclusive, to the next IDR access unit, exclusive, or to the end of the bitstream, whichever appears earlier.

A group of pictures (GOP) and its characteristics may be defined as follows. A GOP can be decoded regardless of whether any previous pictures were decoded. An open GOP is such a group of pictures in which pictures preceding the initial intra picture in output order might not be correctly decodable when the decoding starts from the initial intra picture of the open GOP. In other words, pictures of an open GOP may refer (in inter prediction) to pictures belonging to a previous GOP. An H.264/AVC decoder can recognize an intra picture starting an open GOP from the recovery point SEI message in an H.264/AVC bitstream. An HEVC decoder can recognize an intra picture starting an open GOP, because a specific NAL unit type, CDR NAL unit type, is used for its coded slices. A closed GOP is such a group of pictures in which all pictures can be correctly decoded when the decoding starts from the initial intra picture of the closed GOP. In other words, no picture in a closed GOP refers to any pictures in previous GOPs. In H.264/AVC and HEVC, a closed GOP starts from an IDR access unit. As a result, closed GOP structure has more error resilience potential in comparison to the open GOP structure, however at the cost of possible reduction in the compression efficiency. Open GOP coding structure is potentially more efficient in the compression, due to a larger flexibility in selection of reference pictures.

The bitstream syntax of H.264/AVC and HEVC indicates whether a particular picture is a reference picture for inter prediction of any other picture. Pictures of any coding type (I, P, B) can be reference pictures or non-reference pictures in H.264/AVC and HEVC. The NAL unit header indicates the type of the NAL unit and whether a coded slice contained in the NAL unit is a part of a reference picture or a non-reference picture.

Many hybrid video codecs, including H.264/AVC and HEVC, encode video information in two phases. In the first phase, pixel or sample values in a certain picture area or “block” are predicted. These pixel or sample values can be predicted, for example, by motion compensation mechanisms, which involve finding and indicating an area in one of the previously encoded video frames that corresponds closely to the block being coded. Additionally, pixel or sample values can be predicted by spatial mechanisms which involve finding and indicating a spatial region relationship.

Prediction approaches using image information from a previously coded image can also be called as inter prediction methods which may also be referred to as temporal prediction and motion compensation. Prediction approaches using image information within the same image can also be called as intra prediction methods.

The second phase is one of coding the error between the predicted block of pixels or samples and the original block of pixels or samples. This may be accomplished by transforming the difference in pixel or sample values using a specified transform. This transform may be e.g. a Discrete Cosine Transform (DCT) or a variant thereof. After transforming the difference, the transformed difference is quantized and entropy encoded.

By varying the fidelity of the quantization process, the encoder can control the balance between the accuracy of the pixel or sample representation (i.e. the visual quality of the picture) and the size of the resulting encoded video representation (i.e. the file size or transmission bit rate).

The decoder reconstructs the output video by applying a prediction mechanism similar to that used by the encoder in order to form a predicted representation of the pixel or sample blocks (using the motion or spatial information created by the encoder and included in the compressed representation of the image) and prediction error decoding (the inverse operation of the prediction error coding to recover the quantized prediction error signal in the spatial domain).

After applying pixel or sample prediction and error decoding processes the decoder combines the prediction and the prediction error signals (the pixel or sample values) to form the output video frame.

The decoder (and encoder) may also apply additional filtering processes in order to improve the quality of the output video before passing it for display and/or storing as a prediction reference for the forthcoming pictures in the video sequence.

In many video codecs, including H.264/AVC and HEVC, motion information is indicated by motion vectors associated with each motion compensated image block. Each of these motion vectors represents the displacement of the image block in the picture to be coded (in the encoder) or decoded (at the decoder) and the prediction source block in one of the previously coded or decoded images (or pictures). H.264/AVC and HEVC, as many other video compression standards, divide a picture into a mesh of rectangles, for each of which a similar block in one of the reference pictures is indicated for inter prediction. The location of the prediction block is coded as a motion vector that indicates the position of the prediction block relative to the block being coded.

H.264/AVC and HEVC include a concept of picture order count (POC). A value of POC is derived for each picture and is non-decreasing with increasing picture position in output order. POC therefore indicates the output order of pictures. POC may be used in the decoding process for example for implicit scaling of motion vectors in the temporal direct mode of bi-predictive slices, for implicitly derived weights in weighted prediction, and for reference picture list initialization. Furthermore, POC may be used in the verification of output order conformance. In H.264/AVC, POC is specified relative to the previous IDR picture or a picture containing a memory management control operation marking all pictures as “unused for reference”.

Inter prediction process may be characterized using one or more of the following factors.

The Accuracy of Motion Vector Representation.

For example, motion vectors may be of quarter-pixel accuracy, and sample values in fractional-pixel positions may be obtained using a finite impulse response (FIR) filter.

Block Partitioning for Inter Prediction.

Many coding standards, including H.264/AVC and HEVC, allow selection of the size and shape of the block for which a motion vector is applied for motion-compensated prediction in the encoder, and indicating the selected size and shape in the bitstream so that decoders can reproduce the motion-compensated prediction done in the encoder.

Number of Reference Pictures for Inter Prediction.

The sources of inter prediction are previously decoded pictures. Many coding standards, including H.264/AVC and HEVC, enable storage of multiple reference pictures for inter prediction and selection of the used reference picture on a block basis. For example, reference pictures may be selected on macroblock or macroblock partition basis in H.264/AVC and on PU or CU basis in HEVC. Many coding standards, such as H.264/AVC and HEVC, include syntax structures in the bitstream that enable decoders to create one or more reference picture lists. A reference picture index to a reference picture list may be used to indicate which one of the multiple reference pictures is used for inter prediction for a particular block. A reference picture index may be coded by an encoder into the bitstream in some inter coding modes or it may be derived (by an encoder and a decoder) for example using neighboring blocks in some other inter coding modes.

Motion Vector Prediction.

In order to represent motion vectors efficiently in bitstreams, motion vectors may be coded differentially with respect to a block-specific predicted motion vector. In many video codecs, the predicted motion vectors are created in a predefined way, for example by calculating the median of the encoded or decoded motion vectors of the adjacent blocks. Another way to create motion vector predictions, sometimes referred to as advanced motion vector prediction (AMVP), is to generate a list of candidate predictions from adjacent blocks and/or co-located blocks in temporal reference pictures and signalling the chosen candidate as the motion vector predictor. In addition to predicting the motion vector values, the reference index of previously coded/decoded picture can be predicted. The reference index may be predicted e.g. from adjacent blocks and/or co-located blocks in temporal reference picture. Differential coding of motion vectors may be disabled across slice boundaries.

Multi-Hypothesis Motion-Compensated Prediction.

H.264/AVC and HEVC enable the use of a single prediction block in P slices (herein referred to as uni-predictive slices) or a linear combination of two motion-compensated prediction blocks for bi-predictive slices, which are also referred to as B slices. Individual blocks in B slices may be bi-predicted, uni-predicted, or intra-predicted, and individual blocks in P slices may be uni-predicted or intra-predicted. The reference pictures for a bi-predictive picture may not be limited to be the subsequent picture and the previous picture in output order, but rather any reference pictures may be used. In many coding standards, such as H.264/AVC and HEVC, one reference picture list, referred to as reference picture list 0, is constructed for P slices, and two reference picture lists, list 0 and list 1, are constructed for B slices. For B slices, when prediction in forward direction may refer to prediction from a reference picture in reference picture list 0, and prediction in backward direction may refer to prediction from a reference picture in reference picture list 1, even though the reference pictures for prediction may have any decoding or output order relation to each other or to the current picture.

Weighted Prediction.

Many coding standards use a prediction weight of 1 for prediction blocks of inter (P) pictures and 0.5 for each prediction block of a B picture (resulting into averaging). H.264/AVC allows weighted prediction for both P and B slices. In implicit weighted prediction, the weights are proportional to picture order counts (POC), while in explicit weighted prediction, prediction weights are explicitly indicated.

In many video codecs, the prediction residual after motion compensation is first transformed with a transform kernel (like DCT) and then coded. The reason for this is that often there still exists some correlation among the residual and transform can in many cases help reduce this correlation and provide more efficient coding.

In a draft HEVC, each PU has prediction information associated with it defining what kind of a prediction is to be applied for the pixels within that PU (e.g. motion vector information for inter predicted PUs and intra prediction directionality information for intra predicted PUs). Similarly each TU is associated with information describing the prediction error decoding process for the samples within the TU (including e.g. DCT coefficient information). It may be signaled at CU level whether prediction error coding is applied or not for each CU. In the case there is no prediction error residual associated with the CU, it can be considered there are no TUs for the CU.

In some coding formats and codecs, a distinction is made between so-called short-term and long-term reference pictures. This distinction may affect some decoding processes such as motion vector scaling in the temporal direct mode or implicit weighted prediction. If both of the reference pictures used for the temporal direct mode are short-term reference pictures, the motion vector used in the prediction may be scaled according to the picture order count difference between the current picture and each of the reference pictures. However, if at least one reference picture for the temporal direct mode is a long-term reference picture, default scaling of the motion vector may be used, for example scaling the motion to half may be used. Similarly, if a short-term reference picture is used for implicit weighted prediction, the prediction weight may be scaled according to the POC difference between the POC of the current picture and the POC of the reference picture. However, if a long-term reference picture is used for implicit weighted prediction, a default prediction weight may be used, such as 0.5 in implicit weighted prediction for bi-predicted blocks.

Some video coding formats, such as H.264/AVC, include the frame_num syntax element, which is used for various decoding processes related to multiple reference pictures. In H.264/AVC, the value of frame_num for IDR pictures is 0. The value of frame_num for non-IDR pictures is equal to the frame_num of the previous reference picture in decoding order incremented by 1 (in modulo arithmetic, i.e., the value of frame_num wrap over to 0 after a maximum value of frame_num).

H.264/AVC specifies the process for decoded reference picture marking in order to control the memory consumption in the decoder. The maximum number of reference pictures used for inter prediction, referred to as M, is determined in the sequence parameter set. When a reference picture is decoded, it is marked as “used for reference”. If the decoding of the reference picture caused more than M pictures marked as “used for reference”, at least one picture is marked as “unused for reference”. There are two types of operation for decoded reference picture marking: adaptive memory control and sliding window. The operation mode for decoded reference picture marking is selected on picture basis. The adaptive memory control enables explicit signaling which pictures are marked as “unused for reference” and may also assign long-term indices to short-term reference pictures. The adaptive memory control may require the presence of memory management control operation (MMCO) parameters in the bitstream. MMCO parameters may be included in a decoded reference picture marking syntax structure. If the sliding window operation mode is in use and there are M pictures marked as “used for reference”, the short-term reference picture that was the first decoded picture among those short-term reference pictures that are marked as “used for reference” is marked as “unused for reference”. In other words, the sliding window operation mode results into first-in-first-out buffering operation among short-term reference pictures.

One of the memory management control operations in H.264/AVC causes all reference pictures except for the current picture to be marked as “unused for reference”. An instantaneous decoding refresh (IDR) picture contains only intra-coded slices and causes a similar “reset” of reference pictures.

In a draft HEVC, reference picture marking syntax structures and related decoding processes have been replaced with a reference picture set (RPS) syntax structure and decoding process are used instead for a similar purpose. A reference picture set valid or active for a picture includes all the reference pictures used as reference for the picture and all the reference pictures that are kept marked as “used for reference” for any subsequent pictures in decoding order. There are six subsets of the reference picture set, which are referred to as RefPicSetStCurr0, RefPicSetStCurr1, RefPicSetStFoll0, RefPicSetStFoll1, RefPicSetLtCurr, and RefPicSetLtFoll. The notation of the six subsets is as follows. “Curr” refers to the reference pictures that are included in the reference picture lists of the current picture and hence may be used as inter prediction reference for the current picture. “Foll” refers to reference pictures that are not included in the reference picture lists of the current picture but may be used in subsequent pictures in decoding order as reference pictures. “St” refers to short-term reference pictures, which may generally be identified through a certain number of least significant bits of their POC value. “Lt” refers to long-term reference pictures, which are specifically identified and generally have a greater difference of POC values relative to the current picture than what can be represented by the mentioned certain number of least significant bits. “0” refers to those reference pictures that have a smaller POC value than that of the current picture. “1” refers to those reference pictures that have a greater POC value than that of the current picture. RefPicSetStCurr0, RefPicSetStCurr1, RefPicSetStFoll0 and RefPicSetStFoll1 are collectively referred to as the short-term subset of the reference picture set. RefPicSetLtCurr and RefPicSetLtFoll are collectively referred to as the long-term subset of the reference picture set.

In HEVC, a reference picture set may be specified in a picture parameter set and taken into use in the slice header through an index to the reference picture set. A reference picture set may also be specified in a slice header. A long-term subset of a reference picture set is generally specified only in a slice header, while the short-term subsets of the same reference picture set may be specified in the picture parameter set or slice header. A reference picture set may be coded independently or may be predicted from another reference picture set (known as inter-RPS prediction). When a reference picture set is independently coded, the syntax structure includes up to three loops iterating over different types of reference pictures; short-term reference pictures with lower POC value than the current picture, short-term reference pictures with higher POC value than the current picture, and long-term reference pictures. Each loop entry specifies a picture to be marked as “used for reference”. In general, the picture is specified with a differential POC value. The inter-RPS prediction exploits the fact that the reference picture set of the current picture can be predicted from the reference picture set of a previously decoded picture. This is because all the reference pictures of the current picture are either reference pictures of the previous picture or the previously decoded picture itself. It is only necessary to indicate which of these pictures should be reference pictures and be used for the prediction of the current picture. In both types of reference picture set coding, a flag (used_by_curr_pic_X_flag) is additionally sent for each reference picture indicating whether the reference picture is used for reference by the current picture (included in a *Curr list) or not (included in a *Foll list). Pictures that are included in the reference picture set used by the current slice are marked as “used for reference”, and pictures that are not in the reference picture set used by the current slice are marked as “unused for reference”. If the current picture is an IDR picture, RefPicSetStCurr0, RefPicSetStCurr1, RefPicSetStFoll0, RefPicSetStFoll1, RefPicSetLtCurr, and RefPicSetLtFoll are all set to empty.

A Decoded Picture Buffer (DPB) may be used in the encoder and/or in the decoder. There are two reasons to buffer decoded pictures, for references in inter prediction and for reordering decoded pictures into output order. As H.264/AVC and HEVC provide a great deal of flexibility for both reference picture marking and output reordering, separate buffers for reference picture buffering and output picture buffering may waste memory resources. Hence, the DPB may include a unified decoded picture buffering process for reference pictures and output reordering. A decoded picture may be removed from the DPB when it is no longer used as a reference and is not needed for output.

In many coding modes of H.264/AVC and HEVC, the reference picture for inter prediction is indicated with an index to a reference picture list. The index may be coded with CABAC or variable length coding. In general, the smaller the index is, the shorter the corresponding syntax element may become. In H.264/AVC and HEVC, two reference picture lists (reference picture list 0 and reference picture list 1) are generated for each bi-predictive (B) slice, and one reference picture list (reference picture list 0) is formed for each inter-coded (P) slice. In addition, for a B slice in a draft HEVC standard, a combined list (List C) may be constructed after the final reference picture lists (List 0 and List 1) have been constructed. The combined list may be used for uni-prediction (also known as uni-directional prediction) within B slices.

A reference picture list, such as the reference picture list 0 and the reference picture list 1, may be constructed in two steps: First, an initial reference picture list is generated. The initial reference picture list may be generated for example on the basis of frame_num, POC, temporal_id, or information on the prediction hierarchy such as a GOP structure, or any combination thereof. Second, the initial reference picture list may be reordered by reference picture list reordering (RPLR) commands, also known as reference picture list modification syntax structure, which may be contained in slice headers. The RPLR commands indicate the pictures that are ordered to the beginning of the respective reference picture list.

This second step may also be referred to as the reference picture list modification process, and the RPLR commands may be included in a reference picture list modification syntax structure. If reference picture sets are used, the reference picture list 0 may be initialized to contain RefPicSetStCurr0 first, followed by RefPicSetStCurr1, followed by RefPicSetLtCurr. Reference picture list 1 may be initialized to contain RefPicSetStCurr1 first, followed by RefPicSetStCurr0. The initial reference picture lists may be modified through the reference picture list modification syntax structure, where pictures in the initial reference picture lists may be identified through an entry index to the list.

Since multiview video provides encoders and decoders the possibility to utilize inter-view redundancy, decoded inter-view frames may be included in the reference picture list(s) as well.

The combined list in HEVC may be constructed as follows. If the modification flag for the combined list is zero, the combined list is constructed by an implicit mechanism; otherwise it is constructed by reference picture combination commands included in the bitstream. In the implicit mechanism, reference pictures in List C are mapped to reference pictures from List 0 and List 1 in an interleaved fashion starting from the first entry of List 0, followed by the first entry of List 1 and so forth. Any reference picture that has already been mapped in List C is not mapped again. In the explicit mechanism, the number of entries in List C is signalled, followed by the mapping from an entry in List 0 or List 1 to each entry of List C. In addition, when List 0 and List 1 are identical the encoder has the option of setting the ref_pic_list_combination_flag to 0 to indicate that no reference pictures from List 1 are mapped, and that List C is equivalent to List 0.

Many high efficiency video codecs such as a draft HEVC codec employ an additional motion information coding/decoding mechanism, often called merging/merge mode/process/mechanism, where all the motion information of a block/PU is predicted and used without any modification/correction. The aforementioned motion information for a PU may comprise 1) The information whether ‘the PU is uni-predicted using only reference picture list0’ or ‘the PU is uni-predicted using only reference picture list1’ or ‘the PU is bi-predicted using both reference picture list0 and list1’; 2) Motion vector value corresponding to the reference picture list0; 3) Reference picture index in the reference picture list0; 4) Motion vector value corresponding to the reference picture list1; and 5) Reference picture index in the reference picture list1. Similarly, predicting the motion information is carried out using the motion information of adjacent blocks and/or co-located blocks in temporal reference pictures. A list, often called as a merge list, may be constructed by including motion prediction candidates associated with available adjacent/co-located blocks and the index of selected motion prediction candidate in the list is signalled and the motion information of the selected candidate is copied to the motion information of the current PU. When the merge mechanism is employed for a whole CU and the prediction signal for the CU is used as the reconstruction signal, i.e. prediction residual is not processed, this type of coding/decoding the CU is typically named as skip mode or merge based skip mode. In addition to the skip mode, the merge mechanism may also be employed for individual PUs (not necessarily the whole CU as in skip mode) and in this case, prediction residual may be utilized to improve prediction quality. This type of prediction mode is typically named as an inter-merge mode.

The merge list may be generated on the basis of reference picture list 0 and/or reference picture list 1 for example using the reference picture lists combination syntax structure included in the slice header syntax. There may be a reference picture lists combination syntax structure, created into the bitstream by an encoder and decoded from the bitstream by a decoder, which indicates the contents of the merge list. The syntax structure may indicate that the reference picture list 0 and the reference picture list 1 are combined to be an additional reference picture lists combination used for the prediction units being uni-directional predicted. The syntax structure may include a flag which, when equal to a certain value, indicates that the reference picture list 0 and reference picture list 1 are identical thus reference picture list 0 is used as the reference picture lists combination. The syntax structure may include a list of entries, each specifying a reference picture list (list 0 or list 1) and a reference index to the specified list, where an entry specifies a reference picture to be included in the merge list.

A syntax structure for (decoded) reference picture marking may exist in a video coding system. For example, when the decoding of the picture has been completed, the decoded reference picture marking syntax structure, if present, may be used to adaptively mark pictures as “unused for reference” or “used for long-term reference”. If the decoded reference picture marking syntax structure is not present and the number of pictures marked as “used for reference” can no longer increase, a sliding window reference picture marking may be used, which basically marks the earliest (in decoding order) decoded reference picture as unused for reference.

In scalable video coding, a video signal can be encoded into a base layer and one or more enhancement layers. An enhancement layer may enhance the temporal resolution (i.e., the frame rate), the spatial resolution, or simply the quality of the video content represented by another layer or part thereof. Each layer together with all its dependent layers is one representation of the video signal at a certain spatial resolution, temporal resolution and quality level. In this document, we refer to a scalable layer together with all of its dependent layers as a “scalable layer representation”. The portion of a scalable bitstream corresponding to a scalable layer representation can be extracted and decoded to produce a representation of the original signal at certain fidelity.

SVC uses an inter-layer prediction mechanism, wherein certain information can be predicted from layers other than the currently reconstructed layer or the next lower layer. Information that could be inter-layer predicted includes intra texture, motion and residual data. Inter-layer motion prediction includes the prediction of block coding mode, header information, etc., wherein motion from the lower layer may be used for prediction of the higher layer. In case of intra coding, a prediction from surrounding macroblocks or from co-located macroblocks of lower layers is possible. These prediction techniques do not employ information from earlier coded access units and hence, are referred to as intra prediction techniques. Furthermore, residual data from lower layers can also be employed for prediction of the current layer.

As indicated earlier, MVC is an extension of H.264/AVC. Many of the definitions, concepts, syntax structures, semantics, and decoding processes of H.264/AVC apply also to MVC as such or with certain generalizations or constraints. Some definitions, concepts, syntax structures, semantics, and decoding processes of MVC are described in the following.

An access unit in MVC is defined to be a set of NAL units that are consecutive in decoding order and contain exactly one primary coded picture consisting of one or more view components. In addition to the primary coded picture, an access unit may also contain one or more redundant coded pictures, one auxiliary coded picture, or other NAL units not containing slices or slice data partitions of a coded picture. The decoding of an access unit results in one decoded picture consisting of one or more decoded view components, when decoding errors, bitstream errors or other errors which may affect the decoding do not occur. In other words, an access unit in MVC contains the view components of the views for one output time instance.

A view component in MVC is referred to as a coded representation of a view in a single access unit.

Inter-view prediction may be used in MVC and refers to prediction of a view component from decoded samples of different view components of the same access unit. In MVC, inter-view prediction is realized similarly to inter prediction. For example, inter-view reference pictures are placed in the same reference picture list(s) as reference pictures for inter prediction, and a reference index as well as a motion vector are coded or inferred similarly for inter-view and inter reference pictures.

An anchor picture is a coded picture in which all slices may reference only slices within the same access unit, i.e., inter-view prediction may be used, but no inter prediction is used, and all following coded pictures in output order do not use inter prediction from any picture prior to the coded picture in decoding order. Inter-view prediction may be used for IDR view components that are part of a non-base view. A base view in MVC is a view that has the minimum value of view order index in a coded video sequence. The base view can be decoded independently of other views and does not use inter-view prediction. The base view can be decoded by H.264/AVC decoders supporting only the single-view profiles, such as the Baseline Profile or the High Profile of H.264/AVC.

In the MVC standard, many of the sub-processes of the MVC decoding process use the respective sub-processes of the H.264/AVC standard by replacing term “picture”, “frame”, and “field” in the sub-process specification of the H.264/AVC standard by “view component”, “frame view component”, and “field view component”, respectively. Likewise, terms “picture”, “frame”, and “field” are often used in the following to mean “view component”, “frame view component”, and “field view component”, respectively.

In scalable multiview coding, the same bitstream may contain coded view components of multiple views and at least some coded view components may be coded using quality and/or spatial scalability.

Many video encoders utilize the Lagrangian cost function to find rate-distortion optimal coding modes, for example the desired macroblock mode and associated motion vectors. This type of cost function uses a weighting factor or λ (lambda) to tie together the exact or estimated image distortion due to lossy coding methods and the exact or estimated amount of information required to represent the pixel/sample values in an image area. The Lagrangian cost function may be represented by the equation:

C=D−F+λR

where C is the Lagrangian cost to be minimised, D is the image distortion (for example, the mean-squared error between the pixel/sample values in original image block and in coded image block) with the mode and motion vectors currently considered, λ is a Lagrangian coefficient and R is the number of bits needed to represent the required data to reconstruct the image block in the decoder (including the amount of data to represent the candidate motion vectors).

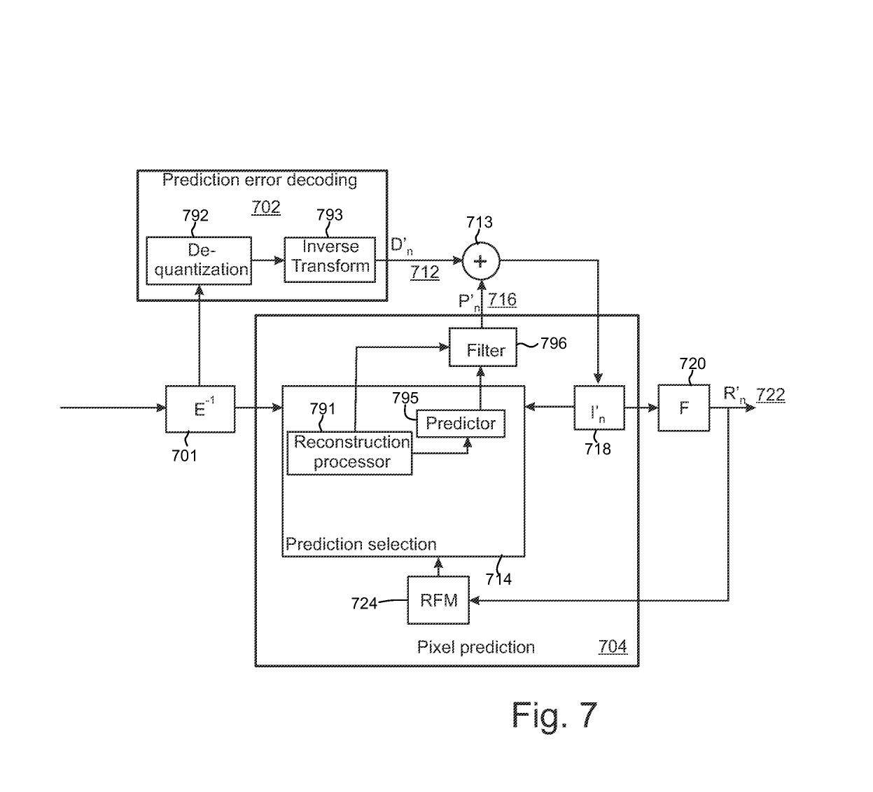

The advanced motion vector prediction may operate for example as follows, while other similar realizations of advanced motion vector prediction are also possible for example with different candidate position sets and candidate locations with candidate position sets. Two spatial motion vector predictors (MVPs) may be derived and a temporal motion vector predictor (TMVP) may be derived. They may be selected among the positions shown in FIG. 8: three spatial motion vector predictor candidate positions located above the current prediction block (B0, B1, B2) and two on the left (A0, A1). The first motion vector predictor that is available (e.g. resides in the same slice, is inter-coded, etc.) in a pre-defined order of each candidate position set, (B0, B1, B2) or (A0, A1), may be selected to represent that prediction direction (up or left) in the motion vector competition. A reference index for the temporal motion vector predictor may be indicated by the encoder in the slice header (e.g. as a collocated_ref_idx syntax element). The motion vector obtained from the co-located picture may be scaled according to the proportions of the picture order count differences of the reference picture of the temporal motion vector predictor, the co-located picture, and the current picture. Moreover, a redundancy check may be performed among the candidates to remove identical candidates, which can lead to the inclusion of a zero motion vector in the candidate list. The motion vector predictor may be indicated in the bitstream for example by indicating the direction of the spatial motion vector predictor (up or left) or the selection of the temporal motion vector predictor candidate.

In addition to predicting the motion vector values, the reference index of previously coded/decoded picture can be predicted. The reference index may be predicted from adjacent blocks and/or from co-located blocks in a temporal reference picture.

In some situations the reference index for temporal motion vector prediction in the merge list is set as 0 in HEVC when the motion coding mode is the merge mode. However, in certain cases, such as when an inter-layer or inter-view reference picture in envisioned scalable or multi-view extensions of HEVC has reference index 0, the picture at reference index 0 may result in invalid temporal motion vector predictor. In this case, the temporal motion vector predictor cannot be used and a loss in coding efficiency may occur.

When the motion coding mode in HEVC utilizing the temporal motion vector prediction is the advanced motion vector prediction mode, the reference index values are explicitly signaled.

When the reference index value is set, the motion vector value of the temporal motion vector prediction may be derived as follows: Motion vector at the block that is co-located with the bottom-right neighbor of the current prediction unit is calculated. The picture where the co-located block resides is determined according to the signaled reference index in the slice header. The determined motion vector at the co-located block is scaled with respect to picture order count difference between co-located block's picture and reference picture of motion vector in the co-located block and picture order count difference between the current picture and the picture at temporal motion vector prediction reference.

The ordering of reference picture lists may be done to make the codewords for reference picture index for advanced motion vector prediction as short as possible. For example, it may be beneficial from the point of view of rate-distortion performance of advanced motion vector prediction that for scalable coding an inter-layer reference picture may occupy reference index 0, for multiview coding an inter-view reference picture may occupy reference index 0 and for depth-enhanced multiview coding a view synthesis reference picture may occupy reference index 0.

In the merge mode, if reference index 0 results in a picture with the same picture order count as the picture order count of the current picture (e.g. inter-layer, inter-view or view synthesis reference picture) or results in a picture where motion vector scaling is not possible, then temporal motion vector prediction cannot be scaled according to picture order count differences. Furthermore, if reference index 0 results in a picture which does not have motion vector data available, for example view synthesis reference picture or a reference picture generated with another coding standard or scheme, temporal motion vector prediction using reference index 0 is not available. However, it may be possible that there are one or more reference pictures associated with reference index greater than 0 from which temporal motion vector prediction could be derived.

A possible solution is that temporal motion vector prediction in advanced motion vector prediction method can be used with a different reference index. However, in this case, for every prediction unit that utilizes the temporal motion vector prediction, the reference index should be explicitly signaled, which may cause loss in coding efficiency. Moreover, it may not be guaranteed that there will be a temporal motion vector prediction for an advanced motion vector prediction list of every prediction unit.

Another possible solution is that the temporal motion vector prediction is not scaled according to picture order count differences. However, this possible solution might not work if the reference index 0 is used for a view synthesis reference picture or a reference picture from another coding standard.

In some embodiments the reference index of temporal motion vector predictor in the merge mode may be explicitly signaled for example in the slice header. In this way, compared to setting it as always 0, it is possible to utilize temporal motion vector prediction even if the picture at reference index equal to 0 would avoid derivation of temporal motion vector prediction.

Therefore, the derivation of temporal motion vector prediction reference picture in the merge mode is not coupled with the ordering of the reference picture lists.

In one implementation, the reference index for the temporal motion vector prediction of the merge mode is signaled in the slice header. It is also possible to implement such that the reference index is signaled at levels higher than slice level such as the Adaptation Parameter Set, the Picture Parameter Set and/or the Sequence Parameter Set. In some embodiments, the presence of the slice header level signaling is indicated in an active parameter set, which may be of any type such as the Adaptation Parameter Set, the Picture Parameter Set, and/or the Sequence Parameter Set.

In some embodiments the reference index for the slice may be automatically derived based on the current reference list and properties of the pictures in the list. One possibility is to fix the reference index (ref_idx) of the temporal motion vector prediction to the reference index (ref_idx) of the closest picture e.g. in terms of absolute picture order count differences within the same layer/view. Another possibility is choosing the first available reference index at or after the index 0. An available reference index may be, for example, determined when one or more of the following conditions is true:

1) The reference index points to a picture among certain types of reference pictures (e.g. among temporal reference pictures or among temporal, inter-layer and inter-view reference pictures but excluding e.g. view synthesis reference picture and/or inter-layer reference pictures from another decoder/bitstream).

2) The reference index is associated to a picture with picture order count different than the picture order count of the current picture.

3) The co-located block for the temporal motion vector prediction derivation in the picture associated with the reference index has a coding mode (e.g. non-intra mode) that enables the temporal motion vector prediction derivation.

In some embodiments, the type or “direction” of the reference picture for the temporal motion vector predictor is signaled by the encoder for example in the slice header and used by the decoder to derive the reference picture for the temporal motion vector predictor. The type or “direction” of the reference picture may for example include some or all of the following but might not be limited to them: temporal (a picture within the same layer and view), inter-view (a picture of a different view), inter-layer (a picture from a different layer). The encoder may choose the type or “direction” of the reference picture for the temporal motion vector predictor for example using rate distortion optimization, in which that type or “direction” that results into best rate-distortion performance among the tested types or “directions” is chosen. The encoder and decoder may use the indicated type or “direction” to select the reference picture for temporal motion vector predictor for example as follows: Let RefPicList be the reference picture list from which the reference picture for temporal motion vector predictor is chosen, i be an index to the reference picture list in the range of 0, inclusive, to the number of pictures in the reference picture list, exclusive, and RefPicList[i] be the i-th picture in the reference picture list. The encoder and the decoder may select the smallest value of i for which RefPicList[i] has the indicated type or “direction”. In some embodiments, a set of types or “directions” may be indicated by the encoder and used by the decoder. For example, the encoder could indicate temporal and inter-layer reference picture types, and the encoder and decoder may select the reference picture for temporal motion vector predictor among the temporal and inter-layer reference pictures within a particular reference picture list, such as reference picture list 0.

In some embodiments, the encoder may choose among more than one derivation process for the reference index among candidate pictures, the encoder may indicate the chosen derivation process within the bitstream for example using one or more syntax elements in the slice header or at levels higher than slice level such as the Adaptation Parameter Set, the Picture Parameter Set and/or the Sequence Parameter Set, the decoder may decode the one or more syntax elements indicating the derivation process for the reference index, and the decoder may use the indicated derivation process in the decoding process. The candidate pictures referred to above may be those that are automatically derived in the absence of the indication for the reference index of the temporal motion vector predictor or they may be those that have the indicated type or “direction” for temporal motion vector predictor within a specific reference picture list, such as reference picture list 0. Examples of the derivation process for the reference index have been described above. For example, if the candidate pictures include temporal reference pictures, the derivation process for the reference index may select the closest picture e.g. in terms of absolute picture order count differences within the same layer/view. Another possibility is choosing the first available reference index at or after the index 0.

In some embodiments, the derivation of the position of the co-located block for the current prediction unit may depend on the type or “direction” of the reference picture for the temporal motion vector predictor. For example, when an inter-layer reference picture is used as a source for temporal motion vector predictor, the co-located block may be selected to be at an identical spatial location as the current prediction unit (when quality scalability or alike is in use) or at an identical spatial location taking into account spatial scaling ratio of the picture extents between the current picture and the reference picture (when spatial scalability is in use). In another example, the co-located block may be selected to be at a position of the current prediction unit shifted by a disparity value, where the disparity value may for example be a global disparity between the current picture and the reference picture, or may be indicated by the encoder, or may be derived from a depth or disparity picture or pictures.

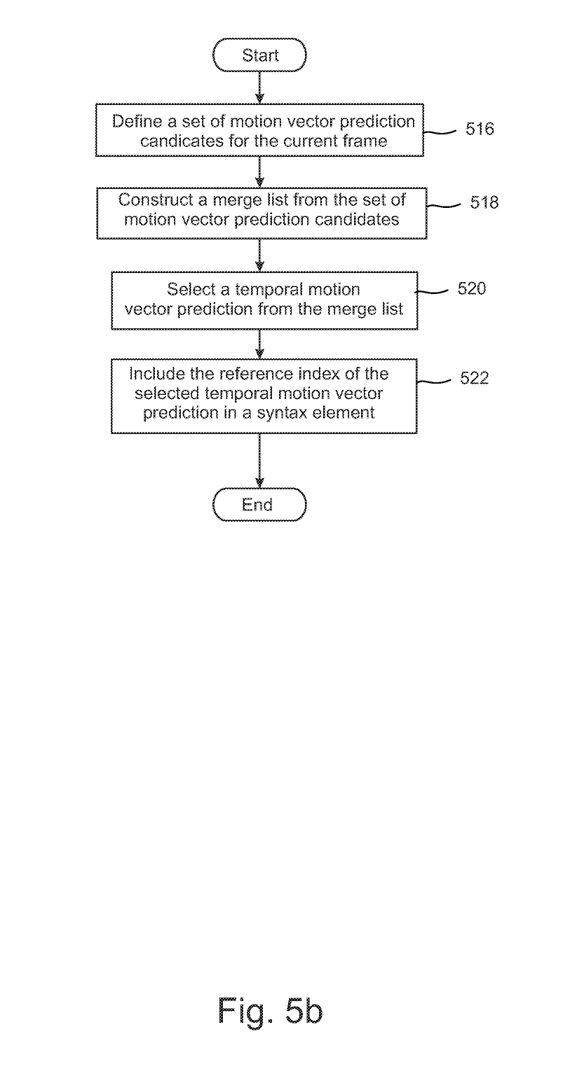

In some embodiments, the scaling of the temporal motion vector predictor may depend on the type or “direction” of the reference picture for the temporal motion vector predictor. For example, if the temporal motion vector predictor originates from an inter-layer reference picture it may not be scaled (when quality scalability or alike is in use) or scaled according to the ratio of the picture extents between the current picture and the reference picture (when spatial scalability is in use). In another example, if the temporal motion vector predictor originates from a temporal reference picture, scaling according to picture order count differences may be performed for example as illustrated with FIG. 6.

In some embodiments, the scaling of the temporal motion vector predictor may depend on the type or “direction” of the motion vector in the co-located block. For example, if the type or “direction” of the motion vector in the co-located block is inter-view, the scaling of the motion vector may be done according to the translation between the cameras (e.g. in terms of physical separation between cameras), camera or view order (e.g. from left to right), view identifier differences, or view order index differences. In another example, if the type or “direction” of the motion vector in the co-located block is temporal and the type of the reference picture is inter-view or inter-layer, the motion vector may not be scaled. In another example, if the type or “direction” of the motion vector in the co-located block is temporal and the type of the reference picture is temporal, scaling according to picture order count differences may be performed for example as illustrated with FIG. 6.

In some embodiments, the encoding and decoding process may use more than one merging candidate for temporal motion vector predictor, and different embodiments may be applied for one or more of these merging candidates. For example, more than one reference indexes for different merging candidates using temporal motion vector predictor may be indicated in the slice header.

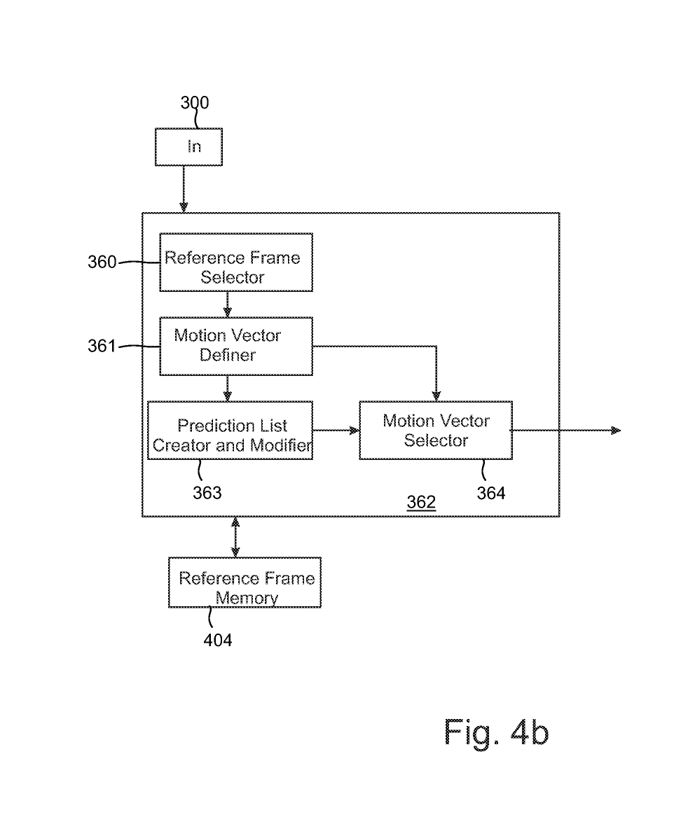

FIGS. 4a and 4b show block diagrams for video encoding and decoding according to an example embodiment.

FIG. 4a shows the encoder as comprising a pixel predictor 302, prediction error encoder 303 and prediction error decoder 304. FIG. 4a also shows an embodiment of the pixel predictor 302 as comprising an inter-predictor 306, an intra-predictor 308, a mode selector 310, a filter 316, and a reference frame memory 318. In this embodiment the mode selector 310 comprises a block processor 381 and a cost evaluator 382. The encoder may further comprise an entropy encoder 330 for entropy encoding the bit stream.

FIG. 4b depicts an embodiment of the inter predictor 306. The inter predictor 306 comprises a reference frame selector 360 for selecting reference frame or frames, a motion vector definer 361, a prediction list former 363 and a motion vector selector 364. These elements or some of them may be part of a prediction processor 362 or they may be implemented by using other means.

The pixel predictor 302 receives the image 300 to be encoded at both the inter-predictor 306 (which determines the difference between the image and a motion compensated reference frame 318) and the intra-predictor 308 (which determines a prediction for an image block based only on the already processed parts of a current frame or picture). The output of both the inter-predictor and the intra-predictor are passed to the mode selector 310. Both the inter-predictor 306 and the intra-predictor 308 may have more than one intra-prediction modes. Hence, the inter-prediction and the intra-prediction may be performed for each mode and the predicted signal may be provided to the mode selector 310. The mode selector 310 also receives a copy of the image 300.

The mode selector 310 determines which encoding mode to use to encode the current block. If the mode selector 310 decides to use an inter-prediction mode it will pass the output of the inter-predictor 306 to the output of the mode selector 310. If the mode selector 310 decides to use an intra-prediction mode it will pass the output of one of the intra-predictor modes to the output of the mode selector 310.

The mode selector 310 may use, in the cost evaluator block 382, for example Lagrangian cost functions to choose between coding modes and their parameter values, such as motion vectors, reference indexes, and intra prediction direction, typically on block basis. This kind of cost function uses a weighting factor lambda to tie together the (exact or estimated) image distortion due to lossy coding methods and the (exact or estimated) amount of information that is required to represent the pixel values in an image area: C=D+lambda×R, where C is the Lagrangian cost to be minimized, D is the image distortion (e.g. Mean Squared Error) with the mode and their parameters, and R the number of bits needed to represent the required data to reconstruct the image block in the decoder (e.g. including the amount of data to represent the candidate motion vectors).

The output of the mode selector is passed to a first summing device 321. The first summing device may subtract the pixel predictor 302 output from the image 300 to produce a first prediction error signal 320 which is input to the prediction error encoder 303.

The pixel predictor 302 further receives from a preliminary reconstructor 339 the combination of the prediction representation of the image block 312 and the output 338 of the prediction error decoder 304. The preliminary reconstructed image 314 may be passed to the intra-predictor 308 and to a filter 316. The filter 316 receiving the preliminary representation may filter the preliminary representation and output a final reconstructed image 340 which may be saved in a reference frame memory 318. The reference frame memory 318 may be connected to the inter-predictor 306 to be used as the reference image against which the future image 300 is compared in inter-prediction operations. In many embodiments the reference frame memory 318 may be capable of storing more than one decoded picture, and one or more of them may be used by the inter-predictor 306 as reference pictures against which the future images 300 are compared in inter prediction operations. The reference frame memory 318 may in some cases be also referred to as the Decoded Picture Buffer.

The operation of the pixel predictor 302 may be configured to carry out any known pixel prediction algorithm known in the art.

The pixel predictor 302 may also comprise a filter 385 to filter the predicted values before outputting them from the pixel predictor 302.

The operation of the prediction error encoder 302 and prediction error decoder 304 will be described hereafter in further detail. In the following examples the encoder generates images in terms of prediction units such as 16×16 pixel macroblocks which go to form the full image or picture. However, it is noted that FIG. 4a is not limited to block size 16×16 and macroblocks, but any block size and shape can be used generally, and likewise FIG. 4a is not limited to partitioning of a picture to macroblocks but any other picture partitioning to blocks, such as coding units, may be used. Thus, for the following examples the pixel predictor 302 outputs a series of predicted macroblocks of size 16×16 pixels and the first summing device 321 outputs a series of 16×16 pixel residual data macroblocks which may represent the difference between a first macroblock in the image 300 against a predicted macroblock (output of pixel predictor 302).

The prediction error encoder 303 comprises a transform block 342 and a quantizer 344. The transform block 342 transforms the first prediction error signal 320 to a transform domain. The transform is, for example, the DCT transform or its variant. The quantizer 344 quantizes the transform domain signal, e.g. the DCT coefficients, to form quantized coefficients.

The prediction error decoder 304 receives the output from the prediction error encoder 303 and produces a decoded prediction error signal 338 which when combined with the prediction representation of the image block 312 at the second summing device 339 produces the preliminary reconstructed image 314. The prediction error decoder may be considered to comprise a dequantizer 346, which dequantizes the quantized coefficient values, e.g. DCT coefficients, to reconstruct the transform signal approximately and an inverse transformation block 348, which performs the inverse transformation to the reconstructed transform signal wherein the output of the inverse transformation block 348 contains reconstructed block(s). The prediction error decoder may also comprise a macroblock filter (not shown) which may filter the reconstructed macroblock according to further decoded information and filter parameters.

In the following the operation of an example embodiment of the inter predictor 306 will be described in more detail. The inter predictor 306 receives the current block for inter prediction. It is assumed that for the current block there already exists one or more neighbouring blocks which have been encoded and motion vectors have been defined for them. For example, the block on the left side and/or the block above the current block may be such blocks. Spatial motion vector predictions for the current block can be formed e.g. by using the motion vectors of the encoded neighbouring blocks and/or of non-neighbour blocks in the same slice or frame, using linear or non-linear functions of spatial motion vector predictions, using a combination of various spatial motion vector predictors with linear or non-linear operations, or by any other appropriate means that do not make use of temporal reference information. It may also be possible to obtain motion vector predictors by combining both spatial and temporal prediction information of one or more encoded blocks. These kinds of motion vector predictors may also be called as spatio-temporal motion vector predictors.

Reference frames used in encoding the neighbouring blocks have been stored to the reference frame memory 404. The reference frames may be short term references or long term references and each reference frame may have a unique index indicative of the location of the reference frame in the reference frame memory. When a reference frame is no longer used as a reference frame it may be removed from the reference frame memory or marked as a non-reference frame wherein the storage location of that reference frame may be occupied for a new reference frame. In addition to the reference frames of the neighbouring blocks the reference frame selector 360 may also select one or more other frames as potential reference frames and store them to the reference frame memory.

Motion vector information of encoded blocks is also stored into the memory so that the inter predictor 306 is able to retrieve the motion vector information when processing motion vector candidates for the current block.

In some embodiments there may be two or more motion vector prediction procedures and each procedure may have its own candidate set creation process. In one procedure, only the motion vector values are used. In another procedure, which, as already mentioned above, may be called as the merging/merge mode/process/mechanism, each candidate element may comprise 1) the information whether ‘block was uni-predicted using only list0’ or ‘block was uni-predicted using only list1’ or ‘block was bi-predicted using list0 and list1’; 2) motion vector value for the reference picture list0; 3) reference picture index in the reference picture list0; 4) motion vector value for the reference picture list1; and 5) reference picture index in the reference picture list1. Therefore, whenever two prediction candidates are to be compared, not only the motion vector values are compared, but also the five values mentioned above may be compared to determine whether they correspond with each other or not. On the other hand, if any of the comparisons indicate that the prediction candidates do not have equal motion information, no further comparisons may not be needed.

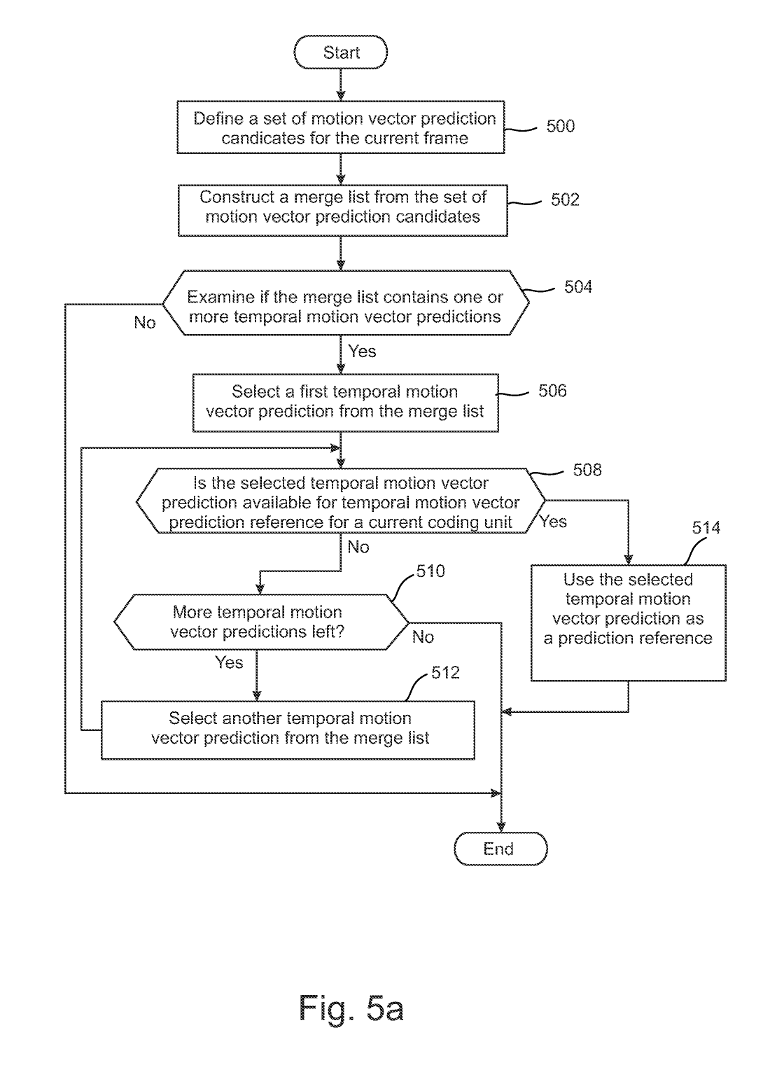

The motion vector definer 361 defines candidate motion vectors for the current frame by using one or more of the motion vectors of one or more neighbour blocks and/or other blocks of the current block in the same frame and/or co-located blocks and/or other blocks of the current block in one or more other frames. This is illustrated with the block 500 in FIG. 5a. These candidate motion vectors can be called as a set of candidate predictors or a predictor set. Each candidate predictor thus represents the motion vector of one or more already encoded block. In some embodiments the motion vector of the candidate predictor is set equal to the motion vector of a neighbour block for the same list if the current block and the neighbour block refer to the same reference frames for that list. Also for temporal prediction there may be one or more previously encoded frames wherein motion vectors of a co-located block or other blocks in a previously encoded frame can be selected as candidate predictors for the current block. The temporal motion vector predictor candidate can be generated by any means that make use of the frames other than the current frame.

The candidate motion vectors can also be obtained by using more than one motion vector of one or more other blocks such as neighbour blocks of the current block and/or co-located blocks in one or more other frames. As an example, any combination of the motion vector of the block to the left of the current block, the motion vector of the block above the current block, and the motion vector of the block at the up-right corner of the current block may be used (i.e. the block to the right of the block above the current block). The combination may be a median of the motion vectors or calculated by using other formulas. For example, one or more of the motion vectors to be used in the combination may be scaled by a scaling factor, an offset may be added, and/or a constant motion vector may be added. In some embodiments the combined motion vector is based on both temporal and spatial motion vectors, e.g. the motion vector of one or more of the neighbour block or other block of the current block and the motion vector of a co-located block or other block in another frame.

If a neighbour block does not have any motion vector information a default motion vector such as a zero motion vector may be used instead.

FIG. 8 illustrates an example of a coding unit 800 and some neighbour blocks 801-805 of the coding unit. As can be seen from FIG. 8, if the coding unit 800 represents the current block, the neighbouring blocks 801-805 labelled A0, A1, B0, B1 and B2 could be such neighbour blocks which may be used when obtaining the spatial candidate motion vectors.

Creating additional or extra motion vector predictions based on previously added predictors may be needed when the current number of candidates is limited or insufficient. This kind of creating additional candidates can be performed by combining previous two predictions and/or processing one previous candidate by scaling or adding offset and/or adding a zero motion vector with various reference indices. Hence, the motion vector definer 361 may examine how many motion vector candidates can be defined and how many potential candidate motion vectors exist for the current block. If the number of potential motion vector candidates is smaller than a threshold, the motion vector definer 361 may create additional motion vector predictions.

To distinguish the current block from the encoded/decoded blocks the motion vectors of which are used as candidate motion vectors, those encoded/decoded blocks are also called as reference blocks in this application.

In some embodiments not only the motion vector information of the reference block(s) is obtained (e.g. by copying) but also a reference index of the reference block in the reference picture list may be copied to the candidate list. The information whether the block was uni-predicted using only list0 or the block was uni-predicted using only list1 or the block was bi-predicted using list0 and list1 may also be copied. The candidate list may also be called as a candidate set or a set of motion vector prediction candidates.

FIG. 6a illustrates an example of spatial and temporal prediction of a prediction unit. There is depicted the current block 601 in the frame 600 and a neighbour block 602 which already has been encoded. The motion vector definer 361 has defined a motion vector 603 for the neighbour block 602 which points to a block 604 in the previous frame 605. This motion vector can be used as a potential spatial motion vector prediction 610 for the current block. FIG. 6a depicts that a co-located block 606 in the previous frame 605, i.e. the block at the same location than the current block but in the previous frame, has a motion vector 607 pointing to a block 609 in another frame 608. This motion vector 607 can be used as a potential temporal motion vector prediction 611 for the current frame.

FIG. 6b illustrates another example of spatial and temporal prediction of a prediction unit. In this example the block 606 of the previous frame 605 uses bi-directional prediction based on the block 609 of the frame preceding the frame 605 and on the block 612 succeeding the current frame 600. The temporal motion vector prediction for the current block 601 may be formed by using both the motion vectors 607, 614 or either of them.

In the following, a merge process for motion information coding according to an example embodiment will be described in more detail. The encoder creates a list of motion prediction candidates from which one of the candidates is to be signalled as the motion information for the current coding unit or prediction unit. This is illustrated with the block 502 in FIG. 5a. The motion prediction candidates may consist of several spatial motion predictions and none, one or more temporal motion predictions. The spatial candidates can be obtained from the motion information of e.g. the spatial neighbour blocks A0, A1, B0, B1, B2, whose motion information is used as spatial candidate motion predictions. The temporal motion prediction candidate(s) may be obtained by processing the motion of a block in a frame other than the current frame.

In this example the spatial motion prediction candidates are the spatial neighbour blocks A0, A1, B0, B1, B2. The spatial motion vector prediction candidate A1 is located on the left side of the prediction unit when the encoding/decoding order is from left to right and from top to bottom of the frame, slice or another entity to be encoded/decoded. Respectively, the spatial motion vector prediction candidate B1 is located above the prediction unit. third; the spatial motion vector prediction candidate B0 is on the right side of the spatial motion vector prediction candidate B1; the spatial motion vector prediction candidate A0 is below the spatial motion vector prediction candidate A1; and the spatial motion vector prediction candidate B2 is located on the same column than spatial motion vector prediction candidate A1 and on the same row than the spatial motion vector prediction candidate B1. In other words, the spatial motion vector prediction candidate B2 is cornerwise neighbouring the prediction unit as can be seen e.g. from FIG. 8.

These spatial motion prediction candidates can be processed in a predetermined order, for example, A1, B 1, B0, A0 and B2. The first spatial motion prediction candidate to be selected for further examination is thus A1. Before further examination is performed for the selected spatial motion prediction candidate, it may be determined whether the merge list already contains a maximum number of spatial motion prediction candidates. Hence, the prediction list modifier 363 compares the number of spatial motion prediction candidates in the merge list with the maximum number, and if the number of spatial motion prediction candidates in the merge list is not less than the maximum number, the selected spatial motion prediction candidate is not included in the merge list and the process of constructing the merge list can be stopped. On the other hand, if the number of spatial motion prediction candidates in the merge list is less than the maximum number, a further analyses of the selected spatial motion prediction candidate may be performed or the spatial motion prediction candidate may be added to the merge list without further analyses.

Some of the motion prediction candidates may have the same motion information, resulting redundancy. Therefore, when merging candidates have the same motion information (e.g. the same motion vectors and the same reference indices), the merging candidates may be discarded for the merge list except the merging candidate which has the smallest processing order. In this way, after discarding the redundant candidates, the list containing the remaining candidates can be called as the original merge list. If the number of candidates in the original merge list is smaller than the maximum number of merge candidates, then additional motion prediction candidates may be generated and included in the merge list in order to make the total number of candidates equal to the maximum number. In summary, the final merge list is composed of the candidates in the original merge list and additional candidates obtained in various ways. One of the ways of generating additional candidates is creating a new candidate by combining motion information corresponding to reference picture list0 of a candidate in the original list with motion information corresponding to reference picture list1 of another candidate in the original merge list. A candidate generated in this way can be called as a combined candidate.

Comparing two blocks whether they have the same motion may be performed by comparing all the elements of the motion information, namely 1) The information whether ‘the prediction unit is un-predicted using only reference picture list0’ or ‘the prediction unit is uni-predicted using only reference picture list1’ or ‘the prediction unit is bi-predicted using both reference picture list0 and list1’; 2) Motion vector value corresponding to the reference picture list0; 3) Reference picture index in the reference picture list0; 4) Motion vector value corresponding to the reference picture list1; and 5) Reference picture index in the reference picture list1.

The maximum number of merge list candidates can be any non-zero value. In the example above the merger list candidates were the spatial neighbour blocks A0, A1, B0, B1, B2 and the temporal motion prediction candidate, but there may be more than one temporal motion prediction candidate and also other spatial motion prediction candidates than the spatial neighbour blocks. In some embodiments there may also be other spatial neighbour blocks than the blocks A0, A1, B0, B1, B2.

It is also possible that the maximum number of spatial motion prediction candidates included in the list can be different than four.

In some embodiments the maximum number of merge list candidates and maximum number of spatial motion prediction candidates included in the list can depend on whether a temporal motion vector candidate is included in the list or not.

A different number of spatial motion prediction candidates located at various locations in the current frame can be processed. The locations can be the same as or different than A1, B1, B0, A0 and B2.

The decisions for the candidates can be taken in any order of A1, B1, B0, A0 and B2 or independently in parallel.

Additional conditions related to various properties of current and/or previous slices and/or current and/or neighbour blocks can be utilized for determining whether to include a candidate in the list.

Motion comparison can be realized by comparing a subset of the whole motion information. For example, only the motion vector values for some or all reference picture lists and/or reference indices for some or all reference picture lists and/or an identifier value assigned to each block to represent its motion information can be compared. The comparison can be an identicality or an equivalence check or comparing the (absolute) difference against a threshold or any other similarity metric.

During the process of removal of redundant candidates, comparison between motion vector predictor candidates can also be based on any other information than the motion vector values. For example, it can be based on linear or non-linear functions of motion vector values, coding or prediction types of the blocks used to obtain the motion information, block size, the spatial location in the frame/(largest) coding unit/macroblock, the information whether blocks share the same motion with a block, the information whether blocks are in the same coding/prediction unit, etc.

In some embodiments, when the merge mode is in use, the temporal motion vector candidate which may have been included in the list, may be set to a value different from 0. For example, the motion vector definer 361 may find out which reference picture(s) in the list has/have a different picture order count than the picture order count of the current slice/coding unit and selects from those reference pictures that one which has the smallest difference in picture order count i.e. is closest to the picture of the current slice. The reference index of the selected picture may then be provided as the reference index of the temporal motion vector prediction.

In some other embodiments the motion vector definer 361 may examine the reference picture(s) in the list e.g. in an increasing order of reference indices, beginning from the index 0, and selects the first reference picture which is available for temporal motion vector prediction. The availability may be determined e.g. on the basis of the type of the reference picture, the picture order count, and/or the coding mode. For example, if the reference index points to a picture among temporal reference pictures or among temporal, inter-layer or inter-view reference pictures, such reference picture may be selected. Additionally or alternatively, if there exists a picture in the list associated with a picture order count different from the picture order count of the current coding unit, it may be selected as the temporal motion vector prediction. Additionally or alternatively, if a picture in the list has e.g. a non-intra coding mode, it may be selected as the temporal motion vector prediction. These steps are illustrated with blocks 504-512 in FIG. 5a.

When the motion vector definer 361 has selected the reference index for the temporal motion vector prediction, the motion vector definer 361 may e.g. inform the block processor 381 of the reference index wherein the block processor 381 or another element of the encoder may use 514 the selected reference picture as a prediction reference for the current block.

In some embodiments the reference index is signalled to the decoder so that the decoder need not determine the reference index but can use the signalled reference index to find out the reference picture the encoder has selected to be used as a prediction reference. The signalling may be performed e.g. as follows. When the motion vector definer 361 has selected the reference index for the temporal motion vector prediction, the motion vector definer 361 may e.g. inform the block processor 381 of the reference index wherein the block processor 381 or another element of the encoder may add 522 the reference index to the slice header, for example, or to a syntax element at another level higher than the slice level, such as the Adaptation Parameter Set, the Picture Parameter Set and/or the Sequence Parameter Set. In addition, in some embodiments the presence of the slice header level signaling is indicated in an active parameter set, which may be of any type such as the Adaptation Parameter Set, the Picture Parameter Set, and/or the Sequence Parameter Set. The selection may be performed e.g. as illustrated in blocks 500-512 of FIG. 5a, or by some other way. In FIG. 5b a generalization of the merge list construction and prediction reference selection procedure is illustrated with blocks 516, 518 and 520.

In some embodiments the type or “direction” of the reference picture for the temporal motion vector predictor is signalled to the decoder so that the decoder need not determine the reference index but can use the derived reference index to find out the reference picture the encoder has selected to be used as a prediction reference. The signalling may be performed e.g. as follows. When the motion vector definer 361 has selected the reference index for the temporal motion vector prediction among possible candidates of different types or “directions” (e.g. the reference pictures of each type having the smallest reference index within the reference picture list among the pictures of the same type), the motion vector definer 361 may e.g. inform the block processor 381 of the reference index wherein the block processor 381 or another element of the encoder may add 522 the type or “direction” of the reference picture to the slice header, for example, or to a syntax element at another level higher than the slice level, such as the Adaptation Parameter Set, the Picture Parameter Set and/or the Sequence Parameter Set. In addition, in some embodiments the presence of the slice header level signaling is indicated in an active parameter set, which may be of any type such as the Adaptation Parameter Set, the Picture Parameter Set, and/or the Sequence Parameter Set.

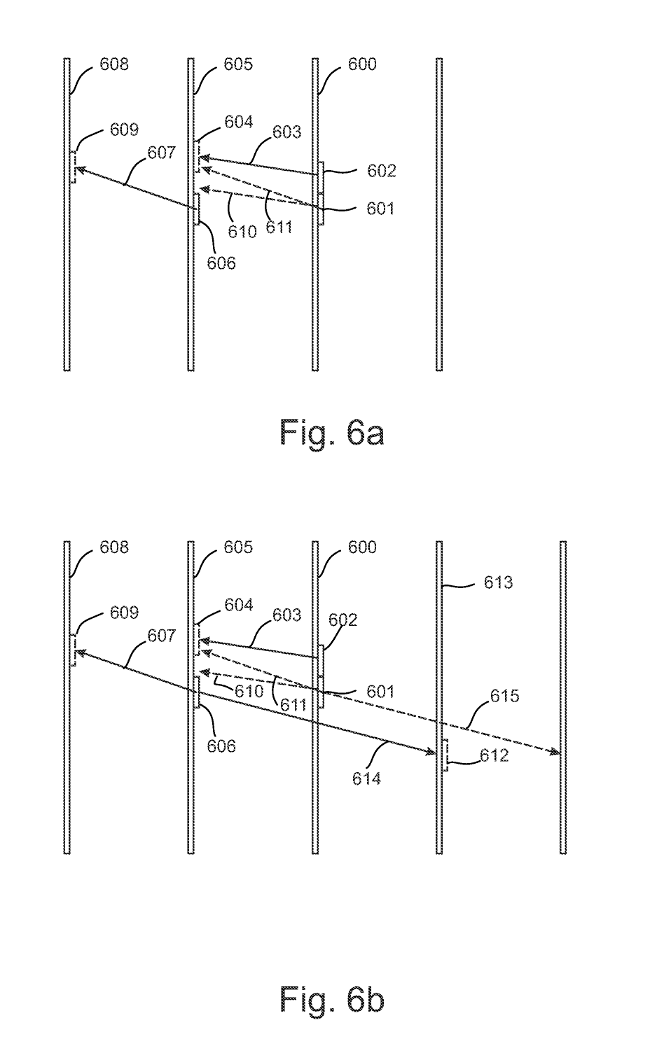

In the following the operation of an example embodiment of the decoder 600 is depicted in more detail with reference to FIG. 7.

At the decoder side similar operations are performed to reconstruct the image blocks. FIG. 7 shows a block diagram of a video decoder 700 suitable for employing embodiments of the invention. The bitstream to be decoded may be received from the encoder, from a network element, from a storage medium or from another source. The decoder is aware of the structure of the bitstream so that it can determine the meaning of the entropy coded codewords and may decode the bitstream by an entropy decoder 701 which performs entropy decoding on the received signal. The entropy decoder thus performs the inverse operation to the entropy encoder 330 of the encoder described above. The entropy decoder 701 outputs the results of the entropy decoding to a prediction error decoder 702 and a pixel predictor 704.

In some embodiments the entropy coding may not be used but another channel encoding may be in use, or the encoded bitstream may be provided to the decoder 700 without channel encoding. The decoder 700 may comprise a corresponding channel decoder to obtain the encoded codewords from the received signal.

The pixel predictor 704 receives the output of the entropy decoder 701. The output of the entropy decoder 701 may include an indication on the prediction mode used in encoding the current block. A predictor selector 714 within the pixel predictor 704 determines that an intra-prediction or an inter-prediction is to be carried out. The predictor selector 714 may furthermore output a predicted representation of an image block 716 to a first combiner 713. The predicted representation of the image block 716 is used in conjunction with the reconstructed prediction error signal 712 to generate a preliminary reconstructed image 718. The preliminary reconstructed image 718 may be used in the predictor 714 or may be passed to a filter 720. The filter 720, if used, applies a filtering which outputs a final reconstructed signal 722. The final reconstructed signal 722 may be stored in a reference frame memory 724, the reference frame memory 724 further being connected to the predictor 714 for prediction operations.

Also the prediction error decoder 702 receives the output of the entropy decoder 701. A dequantizer 792 of the prediction error decoder 702 may dequantize the output of the entropy decoder 701 and the inverse transform block 793 may perform an inverse transform operation to the dequantized signal output by the dequantizer 792. The output of the entropy decoder 701 may also indicate that prediction error signal is not to be applied and in this case the prediction error decoder produces an all zero output signal.

The decoder selects the coding unit to reconstruct. This coding unit is also called as a current block.

The decoder may receive information on the encoding mode used in encoding of the current block. The indication is decoded, when necessary, and provided to the reconstruction processor 791 of the prediction selector 714. The reconstruction processor 791 examines the indication and selects one of the intra-prediction mode(s), if the indication indicates that the block has been encoded using intra-prediction, or the inter-prediction mode, if the indication indicates that the block has been encoded using inter-prediction. The inter-prediction mode may also include the inter-view mode and/or the inter-layer mode.

For inter-prediction mode the reconstruction processor 791 may comprise one or more elements corresponding to the prediction processor 362 of the encoder, such as a motion vector definer, a prediction list modifier and/or a motion vector selector.

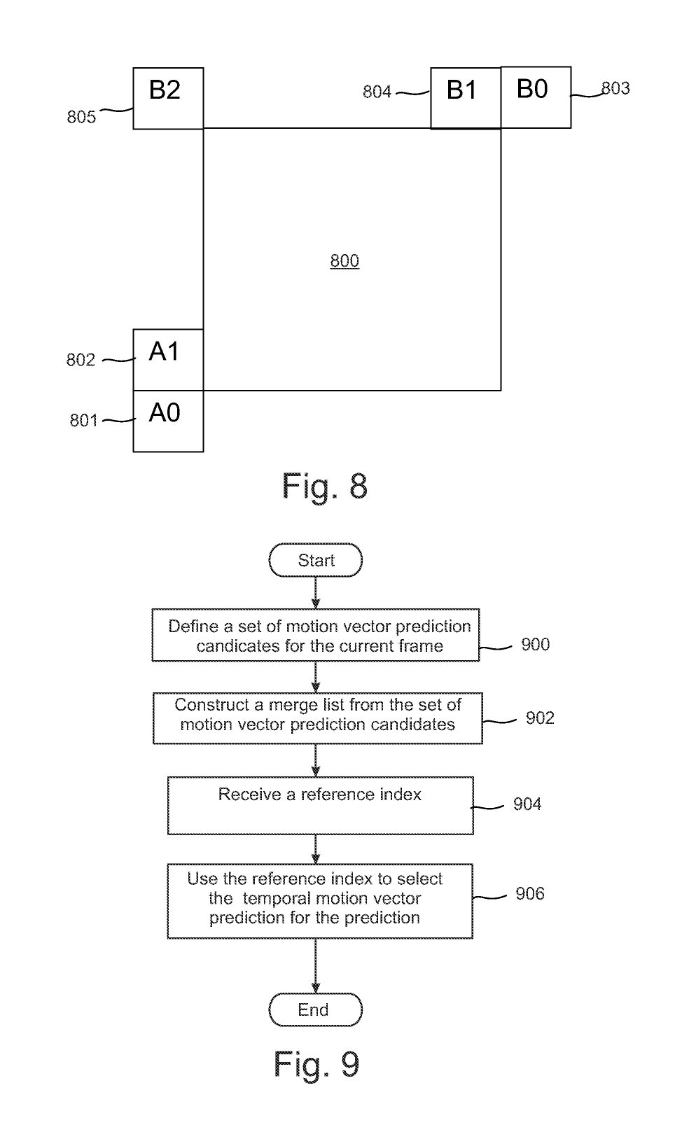

The reconstruction processor 791 reconstucts (illustrated with blocks 900 and 902 in FIG. 9) the motion vector prediction candidate list on the basis of received and decoded information using similar principles than the encoder in constructing the motion vector candidate list.

When the merge list has been constructed the decoder may use 828 the indication of the motion vector possibly received 904 from the encoder to select 906 the motion vector for decoding the current block. The indication may be, for example, an index to the merge list.

In the merge mode, the reconstruction processor 791 may in some embodiments receive the reference index of the selected temporal motion vector prediction from the slice header or from a syntax element at a higher level. In some other embodiments the decoder may not receive the reference index but performs similar or identical analyses or derivation than the encoder to determine the reference index of the temporal motion vector prediction picture the encoder has selected as a reference for the current block. Example embodiments of such analyses or derivation have been described above.

In some embodiments the decoder may have or may decode from the bitstream a parameter which indicates if the reference index of the selected temporal motion vector prediction is signaled in the bitstream (e.g. in a syntax element as illustrated in block 514 of FIG. 5b) or if the decoder should determine the reference index of the selected temporal motion vector prediction. In some other embodiments the parameter which indicates whether or not the reference index of the selected temporal motion vector prediction is signaled in the bitstream may be signaled to the decoder e.g. in some syntax element.

In some embodiments the reconstruction processor 791 may receive, in the context of the merge mode, the type or “direction” of the reference picture of the selected reference picture for temporal motion vector prediction from the slice header or from a syntax element at a higher level. The decoder may then derive the reference index from the indicated type or “direction” similarly or identically to how the encoder derives the reference index. Example embodiments of deriving a reference index from the type or “direction” have been described above.

Basically, after the reconstruction processor 791 has constructed the original merge list and the merge list possibly including combined candidates, these lists would correspond with the original merge list and the merge list possibly including combined candidate constructed by the encoder if the reconstruction processor 791 has the same information available than the encoder had. If some information has been lost during transmission the information from the encoder to the decoder, it may affect the generation of the merge list in the decoder 700.

The above examples describe the operation mainly in the merge mode but the encoder and decoder may also operate in other modes.

In example embodiments, syntax structures, semantics of syntax elements, and decoding process may be specified as follows. Syntax elements in the bitstream are represented in bold type. Each syntax element is described by its name (all lower case letters with underscore characters), optionally its one or two syntax categories, and one or two descriptors for its method of coded representation. The decoding process behaves according to the value of the syntax element and to the values of previously decoded syntax elements. When a value of a syntax element is used in the syntax tables or the text, it appears in regular (i.e., not bold) type. In some cases the syntax tables may use the values of other variables derived from syntax elements values. Such variables appear in the syntax tables, or text, named by a mixture of lower case and upper case letter and without any underscore characters. Variables starting with an upper case letter are derived for the decoding of the current syntax structure and all depending syntax structures. Variables starting with an upper case letter may be used in the decoding process for later syntax structures without mentioning the originating syntax structure of the variable. Variables starting with a lower case letter are only used within the context in which they are derived. In some cases, “mnemonic” names for syntax element values or variable values are used interchangeably with their numerical values. Sometimes “mnemonic” names are used without any associated numerical values. The association of values and names is specified in the text. The names are constructed from one or more groups of letters separated by an underscore character. Each group starts with an upper case letter and may contain more upper case letters.

In example embodiments, common notation for arithmetic operators, logical operators, relational operators, bit-wise operators, assignment operators, and range notation e.g. as specified in H.264/AVC or a draft HEVC may be used. Furthermore, common mathematical functions e.g. as specified in H.264/AVC or a draft HEVC may be used and a common order of precedence and execution order (from left to right or from right to left) of operators e.g. as specified in H.264/AVC or a draft HEVC may be used.

In example embodiments, the following descriptors may be used to specify the parsing process of each syntax element.
b(8): byte having any pattern of bit string (8 bits).
se(v): signed integer Exp-Golomb-coded syntax element with the left bit first.
u(n): unsigned integer using n bits. When n is “v” in the syntax table, the number of bits varies in a manner dependent on the value of other syntax elements. The parsing process for this descriptor is specified by n next bits from the bitstream interpreted as a binary representation of an unsigned integer with most significant bit written first.
ue(v): unsigned integer Exp-Golomb-coded syntax element with the left bit first.

An Exp-Golomb bit string may be converted to a code number (codeNum) for example using the following table:

| Bit string | codeNum |
|---|---|
| 1 | 0 |
| 0 1 0 | 1 |
| 0 1 1 | 2 |
| 0 0 1 0 0 | 3 |
| 0 0 1 0 1 | 4 |
| 0 0 1 1 0 | 5 |
| 0 0 1 1 1 | 6 |
| 0 0 0 1 0 0 0 | 7 |
| 0 0 0 1 0 0 1 | 8 |
| 0 0 0 1 0 1 0 | 9 |
| . . . | . . . |

A code number corresponding to an Exp-Golomb bit string may be converted to se(v) for example using the following table:

| codeNum | syntax element value |
|---|---|
| 0 | 0 |
| 1 | 1 |
| 2 | −1 |
| 3 | 2 |
| 4 | −2 |
| 5 | 3 |
| 6 | −3 |
| . . . | . . . |

In example embodiments, a syntax structure may be specified using the following. A group of statements enclosed in curly brackets is a compound statement and is treated functionally as a single statement. A “while” structure specifies a test of whether a condition is true, and if true, specifies evaluation of a statement (or compound statement) repeatedly until the condition is no longer true. A “do . . . while” structure specifies evaluation of a statement once, followed by a test of whether a condition is true, and if true, specifies repeated evaluation of the statement until the condition is no longer true. An “if . . . else” structure specifies a test of whether a condition is true, and if the condition is true, specifies evaluation of a primary statement, otherwise, specifies evaluation of an alternative statement. The “else” part of the structure and the associated alternative statement is omitted if no alternative statement evaluation is needed. A “for” structure specifies evaluation of an initial statement, followed by a test of a condition, and if the condition is true, specifies repeated evaluation of a primary statement followed by a subsequent statement until the condition is no longer true.

As described above in some embodiments, the reference index for temporal motion vector predictor may be signalled to the decoder so that the decoder need not determine the reference index but can use the signalled reference index to find out the reference picture the encoder has selected to be used as a prediction reference. The signalling may be done by the encoder for example in the slice header syntax structure. For example, the merge_tmvp_ref_idx syntax element may be added to the slice header syntax structure as follows.

| | |
|---|---|
| slice_header( ) { | Descriptor |

| | |
|---|---|
| ... | . . . |
| if( slice_type = = P \| \| slice_type = = B ) | |

| | |
|---|---|
| merge_tmvp_ref_idx | ue(v) |

...

}

merge_tmvp_ref_idx may indicate the index of a reference picture within a reference picture list, such as the reference picture list 0, from which the temporal motion vector predictor is derived. For example, the reference index for temporal merging candidate, i.e. the merging candidate using temporal motion vector prediction, may be set equal to merge_tmvp_ref_idx in the encoding and/or decoding process.

As described above in some embodiments, the type or “direction” of the reference picture for the temporal motion vector predictor is signaled by the encoder for example in the slice header. For example, the merge_tmvp_ref_type syntax element may be added to the slice header syntax structure as follows.

| | |
|---|---|
| slice_header( ) { | Descriptor |

| | |
|---|---|
| ... | . . . |
| if( slice_type = = P \| \| slice_type = = B ) | |

| | |
|---|---|
| merge_tmvp_ref_type | ue(v) |

...

}

merge_tmvp_ref_type may indicate the type or “direction” of a reference picture within a reference picture list, such as reference picture list 0, from which the temporal motion vector predictor is derived. merge_tmvp_ref_type equal to 0 may indicate a temporal reference picture, i.e. a reference picture in the same layer and view as the current picture. merge_tmvp_ref_type equal to 1 may indicate an inter-view reference picture, i.e. a reference picture on a different view than the current picture. merge_tmvp_ref_type equal to 2 may indicate an inter-layer reference picture, i.e. a reference picture of a different layer than the current picture. For example, the reference index for temporal merging candidate, i.e. the merging candidate using temporal motion vector prediction, may be set equal to the smallest index of a reference picture having the indicated type in the reference picture list 0 in the encoding and/or decoding process.

As described above in some embodiments, the derivation process for the reference index for temporal motion vector predictor may be signaled by the encoder for example in the slice header or at levels higher than the slice level such as the Adaptation Parameter Set, the Picture Parameter Set and/or the Sequence Parameter Set. For example, the merge_tmvp_derivation_type syntax element may be added to the picture parameter set syntax structure as follows.

| | |
|---|---|
| pic_parameter_set_rbsp( ) { | Descriptor |

| | |
|---|---|
| ... | . . . |
| merge_tmvp_derivation_type | ue(v) |
| ... | |

}

merge_tmvp_derivation_type may indicate the derivation process to derive the reference index of a reference picture within a reference picture list, such as the reference picture list 0, from which the temporal motion vector predictor is derived. merge_tmvp_derivation_type equal to 0 may indicate that the smallest index within the reference picture list, such as the reference picture list 0, having a type or “direction” that is inferred or indicated to be suitable or available for deriving temporal motion vector predictor is used. If the types or “directions” are inferred, they may for example comprise temporal reference pictures only. If the types or “directions” are indicated, the indication may be for example done using the syntax for merge_tmvp_ref_type as described above. merge_tmvp_derivation_type equal to 1 may indicate that the closest reference picture e.g. in terms of absolute picture order count differences within the same layer/view is used for deriving temporal motion vector predictor. If there are two pictures having the same absolute picture order count difference relative to the current picture, a definite condition may be used to choose between these two pictures, e.g. always selecting the picture with a positive signed picture order count difference relative to the current picture.

As described above in some embodiments, the presence of the slice header level signaling (e.g. the merge_tmvp_ref_idx syntax element as shown above) may be indicated in an active parameter set, which may be of any type such as the Adaptation Parameter Set, the Picture Parameter Set, and/or the Sequence Parameter Set. For example, the Picture Parameter Set syntax structure or anything alike may be appended with the following:

| | |
|---|---|
| pic_parameter_set_rbsp( ) { | Descriptor |

| | |
|---|---|
| ... | |
| merge_tmvp_ref_idx_present_flag | u(1) |
| ... | |

}

merge_tmvp_ref_idx_present_flag equal to 0 may indicate that no related slice header level syntax elements, such as merge_tmvp_ref_idx, are present. merge_tmvp_ref_idx_present_flag equal to 1 may indicate that related slice header level syntax elements are present. With an addition of merge_tmvp_ref_idx_present_flag or similar into a parameter set syntax structure, the slice header syntax may be changed for example as follows:

| | |
|---|---|
| slice_header( ) { | Descriptor |

| | |
|---|---|
| ... | . . . |
| if( merge_tmvp_ref_idx_present_flag && ( | |

slice_type = = P | | slice_type = = B ) )

| | |
|---|---|
| merge_tmvp_ref_idx | ue(v) |

...

}

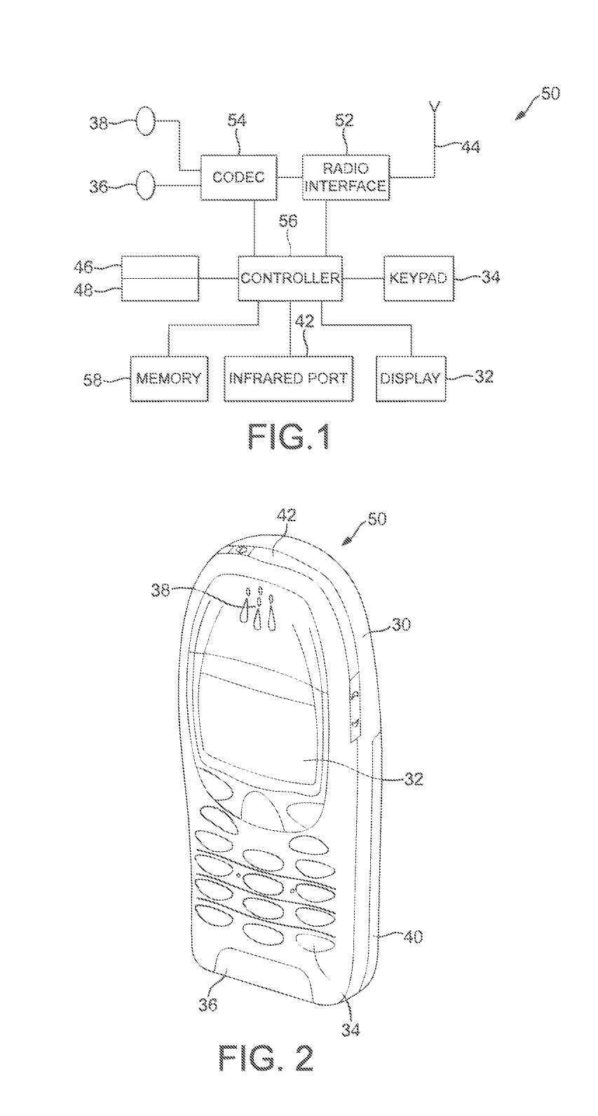

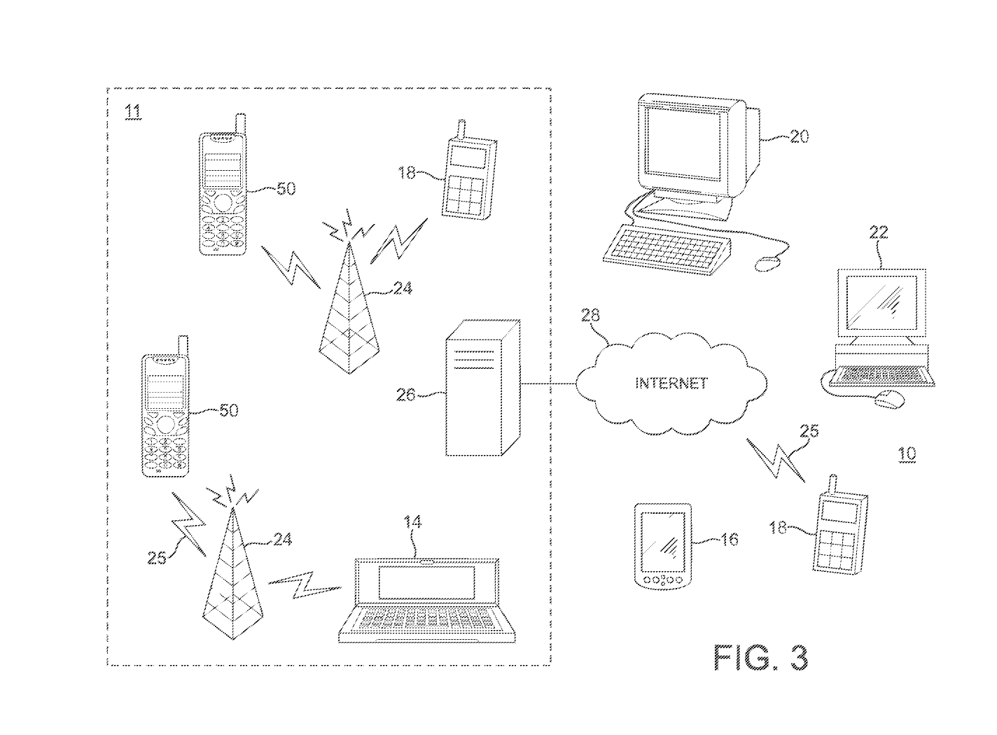

FIG. 1 shows a block diagram of a video coding system according to an example embodiment as a schematic block diagram of an exemplary apparatus or electronic device 50, which may incorporate a codec according to an embodiment of the invention. FIG. 2 shows a layout of an apparatus according to an example embodiment. The elements of FIGS. 1 and 2 will be explained next.

The electronic device 50 may for example be a mobile terminal or user equipment of a wireless communication system. However, it would be appreciated that embodiments of the invention may be implemented within any electronic device or apparatus which may require encoding and decoding or encoding or decoding video images.

The apparatus 50 may comprise a housing 30 for incorporating and protecting the device. The apparatus 50 further may comprise a display 32 in the form of a liquid crystal display. In other embodiments of the invention the display may be any suitable display technology suitable to display an image or video. The apparatus 50 may further comprise a keypad 34. In other embodiments of the invention any suitable data or user interface mechanism may be employed. For example the user interface may be implemented as a virtual keyboard or data entry system as part of a touch-sensitive display. The apparatus may comprise a microphone 36 or any suitable audio input which may be a digital or analogue signal input. The apparatus 50 may further comprise an audio output device which in embodiments of the invention may be any one of: an earpiece 38, speaker, or an analogue audio or digital audio output connection. The apparatus 50 may also comprise a battery 40 (or in other embodiments of the invention the device may be powered by any suitable mobile energy device such as solar cell, fuel cell or clockwork generator). The apparatus may further comprise an infrared port 42 for short range line of sight communication to other devices. In other embodiments the apparatus 50 may further comprise any suitable short range communication solution such as for example a Bluetooth wireless connection or a USB/firewire wired connection.

The apparatus 50 may comprise a controller 56 or processor for controlling the apparatus 50. The controller 56 may be connected to memory 58 which in embodiments of the invention may store both data in the form of image and audio data and/or may also store instructions for implementation on the controller 56. The controller 56 may further be connected to codec circuitry 54 suitable for carrying out coding and decoding of audio and/or video data or assisting in coding and decoding carried out by the controller 56.

The apparatus 50 may further comprise a card reader 48 and a smart card 46, for example a UICC and UICC reader for providing user information and being suitable for providing authentication information for authentication and authorization of the user at a network.

The apparatus 50 may comprise radio interface circuitry 52 connected to the controller and suitable for generating wireless communication signals for example for communication with a cellular communications network, a wireless communications system or a wireless local area network. The apparatus 50 may further comprise an antenna 44 connected to the radio interface circuitry 52 for transmitting radio frequency signals generated at the radio interface circuitry 52 to other apparatus(es) and for receiving radio frequency signals from other apparatus(es).

In some embodiments of the invention, the apparatus 50 comprises a camera capable of recording or detecting individual frames which are then passed to the codec 54 or controller for processing. In some embodiments of the invention, the apparatus may receive the video image data for processing from another device prior to transmission and/or storage. In some embodiments of the invention, the apparatus 50 may receive either wirelessly or by a wired connection the image for coding/decoding.

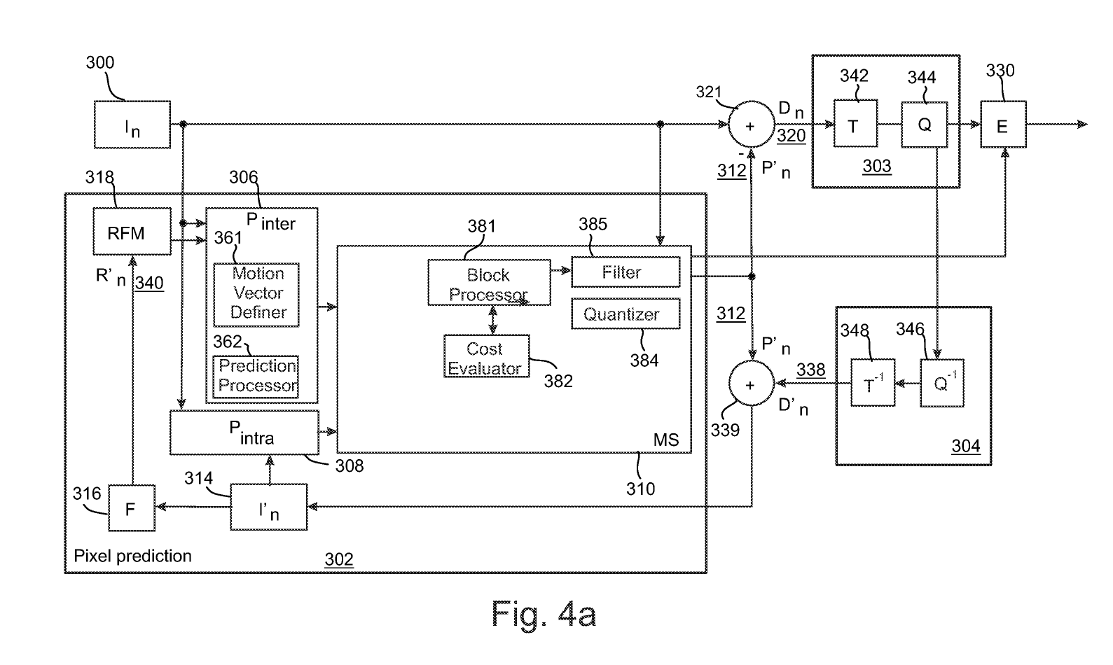

FIG. 3 shows an arrangement for video coding comprising a plurality of apparatuses, networks and network elements according to an example embodiment. With respect to FIG. 3, an example of a system within which embodiments of the present invention can be utilized is shown. The system 10 comprises multiple communication devices which can communicate through one or more networks. The system 10 may comprise any combination of wired or wireless networks including, but not limited to a wireless cellular telephone network (such as a GSM, UMTS, CDMA network etc), a wireless local area network (WLAN) such as defined by any of the IEEE 802.x standards, a Bluetooth personal area network, an Ethernet local area network, a token ring local area network, a wide area network, and the Internet.

The system 10 may include both wired and wireless communication devices or apparatus 50 suitable for implementing embodiments of the invention. For example, the system shown in FIG. 3 shows a mobile telephone network 11 and a representation of the internet 28. Connectivity to the internet 28 may include, but is not limited to, long range wireless connections, short range wireless connections, and various wired connections including, but not limited to, telephone lines, cable lines, power lines, and similar communication pathways.

The example communication devices shown in the system 10 may include, but are not limited to, an electronic device or apparatus 50, a combination of a personal digital assistant (PDA) and a mobile telephone 14, a PDA 16, an integrated messaging device (IMD) 18, a desktop computer 20, a notebook computer 22. The apparatus 50 may be stationary or mobile when carried by an individual who is moving. The apparatus 50 may also be located in a mode of transport including, but not limited to, a car, a truck, a taxi, a bus, a train, a boat, an airplane, a bicycle, a motorcycle or any similar suitable mode of transport.

Some or further apparatuses may send and receive calls and messages and communicate with service providers through a wireless connection 25 to a base station 24. The base station 24 may be connected to a network server 26 that allows communication between the mobile telephone network 11 and the internet 28. The system may include additional communication devices and communication devices of various types.

The communication devices may communicate using various transmission technologies including, but not limited to, code division multiple access (CDMA), global systems for mobile communications (GSM), universal mobile telecommunications system (UMTS), time divisional multiple access (TDMA), frequency division multiple access (FDMA), transmission control protocol-internet protocol (TCP-IP), short messaging service (SMS), multimedia messaging service (MMS), email, instant messaging service (IMS), Bluetooth, IEEE 802.11 and any similar wireless communication technology. A communications device involved in implementing various embodiments of the present invention may communicate using various media including, but not limited to, radio, infrared, laser, cable connections, and any suitable connection.

In the above, the example embodiments have been described with reference to an encoder, it needs to be understood that the resulting bitstream and the decoder have corresponding elements in them. Likewise, where the example embodiments have been described with reference to a decoder, it needs to be understood that the encoder has structure and/or computer program for generating the bitstream to be decoded by the decoder.

Although the above examples describe embodiments of the invention operating within a codec within an electronic device, it would be appreciated that the invention as described below may be implemented as part of any video codec. Thus, for example, embodiments of the invention may be implemented in a video codec which may implement video coding over fixed or wired communication paths.

Thus, user equipment may comprise a video codec such as those described in embodiments of the invention above. It shall be appreciated that the term user equipment is intended to cover any suitable type of wireless user equipment, such as mobile telephones, portable data processing devices or portable web browsers.

Furthermore elements of a public land mobile network (PLMN) may also comprise video codecs as described above.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatuses, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The various embodiments of the invention can be implemented with the help of computer program code that resides in a memory and causes the relevant apparatuses to carry out the invention. For example, a terminal device may comprise circuitry and electronics for handling, receiving and transmitting data, computer program code in a memory, and a processor that, when running the computer program code, causes the terminal device to carry out the features of an embodiment. Yet further, a network device may comprise circuitry and electronics for handling, receiving and transmitting data, computer program code in a memory, and a processor that, when running the computer program code, causes the network device to carry out the features of an embodiment.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs) and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys Inc., of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

In the following some examples will be provided.

According to a first example there is provided a method comprising:

determining a list of prediction reference candidates for a slice of a picture in one or more reference pictures;

associating each prediction reference candidate in the list with a reference index;

selecting a prediction reference candidate for motion vector prediction; providing the reference index associated with the selected prediction reference candidate in a syntax element at a slice level or at a higher level.

In some embodiments of the method the list of prediction reference candidates comprises one or more temporal reference pictures; and the motion vector prediction is a temporal motion vector prediction.

In some embodiments the method comprises using the method in a merge coding mode.

In some embodiments the method comprises performing the motion vector prediction for one or more slices, one or more coding units, one or more frames or one or more pictures.

In some embodiments of the method the selecting comprises examining, if the prediction reference candidate associated with a first reference index is available for motion vector prediction for the slice;

if the examining indicates that the prediction reference candidate with the first reference index is not available for motion vector prediction for the slice, further examining if the list comprises another prediction reference candidate associated with another reference index;

if the further examining indicates that the list comprises another prediction reference candidate associated with another reference index, providing the reference index associated with the other prediction reference candidate in the syntax element.

In some embodiments the method comprises providing a picture order count for the picture, wherein the examining comprises comparing the picture order count of the picture with a picture order count of a reference picture, and if the comparison indicates that the picture order count of the picture is equal to the picture order count of the reference picture, determining that the reference picture is not available for temporal motion vector prediction for the slice.

In some embodiments the method comprises examining the list of prediction reference candidates in an increasing order of reference indices; and selecting the first reference picture which is available for temporal motion vector prediction.

In some embodiments the method comprises determining the availability on the basis of one or more of the following:

a type of the reference picture;

a picture order count;

a coding mode.

In some embodiments of the method the syntax element is signaled at a slice header.

In some embodiments the method comprises signaling the presence of the slice header in an adaptation parameter set, a picture parameter set, or a sequence parameter set.

In some embodiments of the method the syntax element is signaled at one of the following: an adaptation parameter set;

a picture parameter set;

a sequence parameter set.

In some embodiments the method comprises encoding an uncompressed picture into a coded picture comprising the slice.

According to a second example there is provided a method comprising:

determining a list of prediction reference candidates for a slice of a picture in one or more reference pictures;

associating each prediction reference candidate in the list with a reference index;

selecting one of the prediction reference candidates as a prediction reference in encoding the picture by examining the prediction reference candidates.

In some embodiments of the method the list of prediction reference candidates comprises one or more temporal reference pictures; and the motion vector prediction is a temporal motion vector prediction.

In some embodiments of the method the selecting comprises examining, if the prediction reference candidate associated with a first reference index is available for motion vector prediction for the slice;

if the examining indicates that the prediction reference candidate with the first reference index is not available for motion vector prediction for the slice, further examining if the list comprises another prediction reference candidate associated with another reference index;

if the further examining indicates that the list comprises another prediction reference candidate associated with another reference index, selecting the prediction reference candidate as a prediction reference in encoding the picture.

In some embodiments the method comprises providing a picture order count for the picture, wherein the examining comprises comparing the picture order count of the picture with a picture order count of a reference picture, and if the comparison indicates that the picture order count of the picture is equal to the picture order count of the reference picture, determining that the reference picture is not available for temporal motion vector prediction for the slice.

In some embodiments the method comprises examining, whether each reference picture is a long term reference picture or not to determine the availability of a prediction reference candidate for motion vector prediction.

In some embodiments of the method the examining comprising examining, whether each reference picture belongs to the same layer than the current picture or not to determine the availability of a prediction reference candidate for motion vector prediction.

In some embodiments of the method comprises the examining comprising checking, whether each reference picture belongs to the same view of the current picture or not to determine the availability of a prediction reference candidate for motion vector prediction.

According to a third example there is provided an apparatus comprising at least one processor and at least one memory including computer program code, the at least one memory and the computer program code configured to, with the at least one processor, cause the apparatus to:

determine a list of prediction reference candidates for a slice of a picture in one or more reference pictures;

associate each prediction reference candidate in the list with a reference index;

select a prediction reference candidate associated with a reference index for motion vector prediction;

provide the reference index associated with the prediction reference candidate in a syntax element at a slice level or at a higher level.

In some embodiments of the apparatus the list of prediction reference candidates comprises one or more temporal reference pictures; and the motion vector prediction is a temporal motion vector prediction.

In some embodiments of the apparatus said at least one memory stored with code thereon, which when executed by said at least one processor, further causes the apparatus to use the method in a merge coding mode.

In some embodiments of the apparatus said at least one memory stored with code thereon, which when executed by said at least one processor, further causes the apparatus to perform the motion vector prediction for one or more slices, one or more coding units, one or more frames or one or more pictures.

In some embodiments of the apparatus said at least one memory stored with code thereon, which when executed by said at least one processor, further causes the apparatus to examine, if the prediction reference candidate associated with a first reference index is available for motion vector prediction for the slice;

if the examining indicates that the prediction reference candidate with the first reference index is not available for motion vector prediction for the slice, to further examine if the list comprises another prediction reference candidate associated with another reference index;

if the further examining indicates that the list comprises another prediction reference candidate associated with another reference index, to provide the reference index associated with the other prediction reference candidate in the syntax element.

In some embodiments of the apparatus a picture order count is provided for the picture, wherein said at least one memory stored with code thereon, which when executed by said at least one processor, further causes the apparatus to compare the picture order count of the picture with a picture order count of a reference picture, and if the comparison indicates that the picture order count of the picture is equal to the picture order count of the reference picture, to determine that the reference picture is not available for temporal motion vector prediction for the slice.

In some embodiments of the apparatus said at least one memory stored with code thereon, which when executed by said at least one processor, further causes the apparatus to examine the list of prediction reference candidates in an increasing order of reference indices; and to select the first reference picture which is available for temporal motion vector prediction.

In some embodiments of the apparatus said at least one memory stored with code thereon, which when executed by said at least one processor, further causes the apparatus to determine the availability on the basis of one or more of the following:

a type of the reference picture;

a picture order count;

a coding mode.

In some embodiments of the apparatus the syntax element is signaled at a slice header.

In some embodiments of the apparatus said at least one memory stored with code thereon, which when executed by said at least one processor, further causes the apparatus to signal the presence of the slice header in an adaptation parameter set, a picture parameter set, or a sequence parameter set.

In some embodiments of the apparatus the syntax element is signaled at one of the following:

an adaptation parameter set;

a picture parameter set;

a sequence parameter set.

In some embodiments of the apparatus said at least one memory stored with code thereon, which when executed by said at least one processor, further causes the apparatus to encode an uncompressed picture into a coded picture comprising the slice.

According to a fourth example there is provided an apparatus comprising at least one processor and at least one memory including computer program code, the at least one memory and the computer program code configured to, with the at least one processor, cause the apparatus to:

determine a list of prediction reference candidates for a slice of a picture in one or more reference pictures;

associate each prediction reference candidate in the list with a reference index;

select one of the prediction reference candidates as a prediction reference in encoding the picture by examining the prediction reference candidates.

In some embodiments of the apparatus the list of prediction reference candidates comprises one or more temporal reference pictures; and the motion vector prediction is a temporal motion vector prediction.

In some embodiments of the apparatus said at least one memory stored with code thereon, which when executed by said at least one processor, further causes the apparatus to examine, if the prediction reference candidate associated with a first reference index is available for motion vector prediction for the slice;

if the examining indicates that the prediction reference candidate with the first reference index is not available for motion vector prediction for the slice, to further examine if the list comprises another prediction reference candidate associated with another reference index;

if the further examining indicates that the list comprises another prediction reference candidate associated with another reference index, to select the prediction reference candidate as a prediction reference in encoding the picture.

In some embodiments of the apparatus said at least one memory stored with code thereon, which when executed by said at least one processor, further causes the apparatus to provide a picture order count for the picture, wherein the examining comprises comparing the picture order count of the picture with a picture order count of a reference picture, and if the comparison indicates that the picture order count of the picture is equal to the picture order count of the reference picture, to determine that the reference picture is not available for temporal motion vector prediction for the slice.

In some embodiments of the apparatus said at least one memory stored with code thereon, which when executed by said at least one processor, further causes the apparatus to examine, whether each reference picture is a long term reference picture or not to determine the availability of a prediction reference candidate for motion vector prediction.

In some embodiments of the apparatus said at least one memory stored with code thereon, which when executed by said at least one processor, further causes the apparatus to examine, whether each reference picture belongs to the same layer than the current picture or not to determine the availability of a prediction reference candidate for motion vector prediction.

In some embodiments of the apparatus said at least one memory stored with code thereon, which when executed by said at least one processor, further causes the apparatus to check, whether each reference picture belongs to the same view of the current picture or not to determine the availability of a prediction reference candidate for motion vector prediction.

According to a fifth example there is provided a computer program product including one or more sequences of one or more instructions which, when executed by one or more processors, cause an apparatus to at least perform the following:

determine a list of prediction reference candidates for a slice of a picture in one or more reference pictures;

associate each prediction reference candidate in the list with a reference index;

select a prediction reference candidate associated with a reference index for motion vector prediction;

provide the reference index associated with the prediction reference candidate in a syntax element at a slice level or at a higher level.

In some embodiments of the computer program product the list of prediction reference candidates comprises one or more temporal reference pictures; and the motion vector prediction is a temporal motion vector prediction.

In some embodiments the computer program product includes one or more sequences of one or more instructions which, when executed by one or more processors, cause the apparatus to use the method in a merge coding mode.

In some embodiments the computer program product includes one or more sequences of one or more instructions which, when executed by one or more processors, cause the apparatus to perform the motion vector prediction for one or more slices, one or more coding units, one or more frames or one or more pictures.

In some embodiments the computer program product includes one or more sequences of one or more instructions which, when executed by one or more processors, cause the apparatus to examine, if the prediction reference candidate associated with a first reference index is available for motion vector prediction for the slice;

if the examining indicates that the prediction reference candidate with the first reference index is not available for motion vector prediction for the slice, to further examine if the list comprises another prediction reference candidate associated with another reference index;

if the further examining indicates that the list comprises another prediction reference candidate associated with another reference index, to provide the reference index associated with the other prediction reference candidate in the syntax element.

In some embodiments the computer program product includes one or more sequences of one or more instructions which, when executed by one or more processors, cause the apparatus to compare the picture order count of the picture with a picture order count of a reference picture, and if the comparison indicates that the picture order count of the picture is equal to the picture order count of the reference picture, to determine that the reference picture is not available for temporal motion vector prediction for the slice.

In some embodiments the computer program product includes one or more sequences of one or more instructions which, when executed by one or more processors, cause the apparatus to examine the list of prediction reference candidates in an increasing order of reference indices; and to select the first reference picture which is available for temporal motion vector prediction.

In some embodiments the computer program product includes one or more sequences of one or more instructions which, when executed by one or more processors, cause the apparatus to determine the availability on the basis of one or more of the following:

a type of the reference picture;

a picture order count;

a coding mode.

In some embodiments of the computer program product the syntax element is signaled at a slice header.

In some embodiments the computer program product includes one or more sequences of one or more instructions which, when executed by one or more processors, cause the apparatus to signal the presence of the slice header in an adaptation parameter set, a picture parameter set, or a sequence parameter set.

In some embodiments of the computer program product the syntax element is signaled at one of the following:

an adaptation parameter set;

a picture parameter set;

a sequence parameter set.

In some embodiments the computer program product includes one or more sequences of one or more instructions which, when executed by one or more processors, cause the apparatus to encode an uncompressed picture into a coded picture comprising the slice.

According to a sixth example there is provided a computer program product including one or more sequences of one or more instructions which, when executed by one or more processors, cause an apparatus to at least perform the following:

determine a list of prediction reference candidates for a slice of a picture in one or more reference pictures;

associate each prediction reference candidate in the list with a reference index;

select one of the prediction reference candidates as a prediction reference in encoding the picture by examining the prediction reference candidates.

In some embodiments of the computer program product the list of prediction reference candidates comprises one or more temporal reference pictures; and the motion vector prediction is a temporal motion vector prediction.

In some embodiments the computer program product includes one or more sequences of one or more instructions which, when executed by one or more processors, cause the apparatus to examine, if the prediction reference candidate associated with a first reference index is available for motion vector prediction for the slice;

if the examining indicates that the prediction reference candidate with the first reference index is not available for motion vector prediction for the slice, to further examine if the list comprises another prediction reference candidate associated with another reference index;

if the further examining indicates that the list comprises another prediction reference candidate associated with another reference index, to select the prediction reference candidate as a prediction reference in encoding the picture.

In some embodiments the computer program product includes one or more sequences of one or more instructions which, when executed by one or more processors, cause the apparatus to provide a picture order count for the picture, wherein the examining comprises comparing the picture order count of the picture with a picture order count of a reference picture, and if the comparison indicates that the picture order count of the picture is equal to the picture order count of the reference picture, to determine that the reference picture is not available for temporal motion vector prediction for the slice.

In some embodiments the computer program product includes one or more sequences of one or more instructions which, when executed by one or more processors, cause the apparatus to examine, whether each reference picture is a long term reference picture or not to determine the availability of a prediction reference candidate for motion vector prediction.

In some embodiments the computer program product includes one or more sequences of one or more instructions which, when executed by one or more processors, cause the apparatus to examine, whether each reference picture belongs to the same layer than the current picture or not to determine the availability of a prediction reference candidate for motion vector prediction.

In some embodiments the computer program product includes one or more sequences of one or more instructions which, when executed by one or more processors, cause the apparatus to check, whether each reference picture belongs to the same view of the current picture or not to determine the availability of a prediction reference candidate for motion vector prediction.

According to a seventh example there is provided an apparatus comprising:

means for determining a list of prediction reference candidates for a slice of a picture in one or more reference pictures;

means for associating each prediction reference candidate in the list with a reference index;

means for selecting a prediction reference candidate for motion vector prediction;

means for providing the reference index associated with the selected prediction reference candidate in a syntax element at a slice level or at a higher level.

According to an eighth example there is provided an apparatus comprising:

means for determining a list of prediction reference candidates for a slice of a picture in one or more reference pictures;

means for associating each prediction reference candidate in the list with a reference index;

means for selecting one of the prediction reference candidates as a prediction reference in encoding the picture by examining the prediction reference candidates.

According to a ninth example there is provided a method comprising:

determining a list of prediction reference candidates for a slice of a picture in one or more reference pictures;

associating each prediction reference candidate in the list with a reference index;

receiving a syntax element including a reference index indicative of a prediction reference candidate used for motion vector prediction in decoding;

using the reference index to select the prediction reference for decoding the slice.

In some embodiments of the method the list of prediction reference candidates comprises one or more temporal reference pictures; and the motion vector prediction is a temporal motion vector prediction.

In some embodiments the method is used in a merge coding mode.

In some embodiments the method comprises performing the motion vector prediction for one or more slices, one or more coding units, one or more frames or one or more pictures.

In some embodiments of the method the syntax element is signaled at a slice header.

In some embodiments the method comprises receiving an indication of the presence of the slice header in an adaptation parameter set, a picture parameter set, or a sequence parameter set.

In some embodiments of the method the syntax element is signaled at one of the following:

an adaptation parameter set;

a picture parameter set;

a sequence parameter set.

According to a tenth example there is provided a method comprising:

determining a list of prediction reference candidates for a slice of a picture in one or more reference pictures;

associating each prediction reference candidate in the list with a reference index;

selecting one of the prediction reference candidates as a prediction reference in decoding the picture by examining the prediction reference candidates.

In some embodiments of the method the list of prediction reference candidates comprises one or more temporal reference pictures; and the motion vector prediction is a temporal motion vector prediction.

In some embodiments of the method the examining comprising examining, if the prediction reference candidate associated with a first reference index is available for motion vector prediction for the slice;

if the examining indicates that the prediction reference candidate with the first reference index is not available for motion vector prediction for the slice, further examining if the list comprises another prediction reference candidate associated with another reference index;

if the further examining indicates that the list comprises another prediction reference candidate associated with another reference index, selecting the prediction reference candidate as a prediction reference in decoding the picture.

In some embodiments the method comprises providing a picture order count for the picture, wherein the examining comprises comparing the picture order count of the picture with a picture order count of a reference picture, and if the comparison indicates that the picture order count of the picture is equal to the picture order count of the reference picture, determining that the reference picture is not available for temporal motion vector prediction for the slice.

In some embodiments of the method the examining comprises examining, whether each reference picture is a long term reference picture or not to determine the availability of a prediction reference candidate for motion vector prediction.

In some embodiments the method comprises examining, whether each reference picture belongs to the same layer than the current picture or not to determine the availability of a prediction reference candidate for motion vector prediction.

In some embodiments of the method the examining comprises checking, whether each reference picture belongs to the same view of the current picture or not to determine the availability of a prediction reference candidate for motion vector prediction.

According to an eleventh example there is provided an apparatus comprising at least one processor and at least one memory including computer program code, the at least one memory and the computer program code configured to, with the at least one processor, cause the apparatus to:

determine a list of prediction reference candidates for a slice of a picture in one or more reference pictures;

associate each prediction reference candidate in the list with a reference index;

receive a syntax element including a reference index indicative of a prediction reference candidate used for motion vector prediction in decoding;

use the reference index to select the prediction reference for decoding the slice.

In some embodiments of the apparatus the list of prediction reference candidates comprises one or more temporal reference pictures; and the motion vector prediction is a temporal motion vector prediction.

In some embodiments of the apparatus said at least one memory stored with code thereon, which when executed by said at least one processor, further causes the apparatus to use the method in a merge coding mode.

In some embodiments of the apparatus said at least one memory stored with code thereon, which when executed by said at least one processor, further causes the apparatus to perform the motion vector prediction for one or more slices, one or more coding units, one or more frames or one or more pictures.

In some embodiments of the apparatus the syntax element is signaled at a slice header.

In some embodiments of the apparatus said at least one memory stored with code thereon, which when executed by said at least one processor, further causes the apparatus to receive an indication of the presence of the slice header in an adaptation parameter set, a picture parameter set, or a sequence parameter set.

In some embodiments of the apparatus the syntax element is signaled at one of the following:

an adaptation parameter set;

a picture parameter set;

a sequence parameter set.

According to a twelfth example there is provided an apparatus comprising at least one processor and at least one memory including computer program code, the at least one memory and the computer program code configured to, with the at least one processor, cause the apparatus to:

determine a list of prediction reference candidates for a slice of a picture in one or more reference pictures;

associate each prediction reference candidate in the list with a reference index;

select one of the prediction reference candidates as a prediction reference in decoding the picture by examining the prediction reference candidates.

In some embodiments of the apparatus the list of prediction reference candidates comprises one or more temporal reference pictures; and the motion vector prediction is a temporal motion vector prediction.

In some embodiments of the apparatus said at least one memory stored with code thereon, which when executed by said at least one processor, further causes the apparatus to examine, if the prediction reference candidate associated with a first reference index is available for motion vector prediction for the slice;

if the examining indicates that the prediction reference candidate with the first reference index is not available for motion vector prediction for the slice, to further examine if the list comprises another prediction reference candidate associated with another reference index;

if the further examining indicates that the list comprises another prediction reference candidate associated with another reference index, to select the prediction reference candidate as a prediction reference in decoding the picture.

In some embodiments of the apparatus said at least one memory stored with code thereon, which when executed by said at least one processor, further causes the apparatus to provide a picture order count for the picture, wherein the examining comprises comparing the picture order count of the picture with a picture order count of a reference picture, and if the comparison indicates that the picture order count of the picture is equal to the picture order count of the reference picture, to determine that the reference picture is not available for temporal motion vector prediction for the slice.

In some embodiments of the apparatus said at least one memory stored with code thereon, which when executed by said at least one processor, further causes the apparatus to examine, whether each reference picture is a long term reference picture or not to determine the availability of a prediction reference candidate for motion vector prediction.

In some embodiments of the apparatus said at least one memory stored with code thereon, which when executed by said at least one processor, further causes the apparatus to examine, whether each reference picture belongs to the same layer than the current picture or not to determine the availability of a prediction reference candidate for motion vector prediction.

In some embodiments of the apparatus said at least one memory stored with code thereon, which when executed by said at least one processor, further causes the apparatus to check, whether each reference picture belongs to the same view of the current picture or not to determine the availability of a prediction reference candidate for motion vector prediction.

According to a thirteenth example there is provided a computer program product including one or more sequences of one or more instructions which, when executed by one or more processors, cause an apparatus to at least perform the following:

determine a list of prediction reference candidates for a slice of a picture in one or more reference pictures;

associate each prediction reference candidate in the list with a reference index;

receive a syntax element including a reference index indicative of a prediction reference candidate used for motion vector prediction in decoding;

use the reference index to select the prediction reference for decoding the slice.

In some embodiments of the computer program product the list of prediction reference candidates comprises one or more temporal reference pictures; and the motion vector prediction is a temporal motion vector prediction.

In some embodiments the computer program product includes one or more sequences of one or more instructions which, when executed by one or more processors, cause the apparatus to use the method in a merge coding mode.

In some embodiments the computer program product includes one or more sequences of one or more instructions which, when executed by one or more processors, cause the apparatus to perform the motion vector prediction for one or more slices, one or more coding units, one or more frames or one or more pictures.

In some embodiments of the computer program product the syntax element is signaled at a slice header.

In some embodiments the computer program product includes one or more sequences of one or more instructions which, when executed by one or more processors, cause the apparatus to receive an indication of the presence of the slice header in an adaptation parameter set, a picture parameter set, or a sequence parameter set.

In some embodiments of the computer program product the syntax element is signaled at one of the following:

an adaptation parameter set;

a picture parameter set;

a sequence parameter set.

According to a fourteenth example there is provided a computer program product including one or more sequences of one or more instructions which, when executed by one or more processors, cause an apparatus to at least perform the following:

determine a list of prediction reference candidates for a slice of a picture in one or more reference pictures;

associate each prediction reference candidate in the list with a reference index;

select one of the prediction reference candidates as a prediction reference in decoding the picture by examining the prediction reference candidates.

In some embodiments of the computer program product the list of prediction reference candidates comprises one or more temporal reference pictures; and the motion vector prediction is a temporal motion vector prediction.

In some embodiments the computer program product includes one or more sequences of one or more instructions which, when executed by one or more processors, cause the apparatus to examine, if the prediction reference candidate associated with a first reference index is available for motion vector prediction for the slice;

if the examining indicates that the prediction reference candidate with the first reference index is not available for motion vector prediction for the slice, to further examine if the list comprises another prediction reference candidate associated with another reference index;

if the further examining indicates that the list comprises another prediction reference candidate associated with another reference index, to select the prediction reference candidate as a prediction reference in decoding the picture.

In some embodiments the computer program product includes one or more sequences of one or more instructions which, when executed by one or more processors, cause the apparatus to provide a picture order count for the picture, wherein the examining comprises comparing the picture order count of the picture with a picture order count of a reference picture, and if the comparison indicates that the picture order count of the picture is equal to the picture order count of the reference picture, to determine that the reference picture is not available for temporal motion vector prediction for the slice.

In some embodiments the computer program product includes one or more sequences of one or more instructions which, when executed by one or more processors, cause the apparatus to examine, whether each reference picture is a long term reference picture or not to determine the availability of a prediction reference candidate for motion vector prediction.

In some embodiments the computer program product includes one or more sequences of one or more instructions which, when executed by one or more processors, cause the apparatus to examine, whether each reference picture belongs to the same layer than the current picture or not to determine the availability of a prediction reference candidate for motion vector prediction.

In some embodiments the computer program product includes one or more sequences of one or more instructions which, when executed by one or more processors, cause the apparatus to check, whether each reference picture belongs to the same view of the current picture or not to determine the availability of a prediction reference candidate for motion vector prediction.

According to a fifteenth example there is provided an apparatus comprising:

means for determining a list of prediction reference candidates for a slice of a picture in one or more reference pictures;

means for associating each prediction reference candidate in the list with a reference index;

means for selecting a prediction reference candidate for motion vector prediction in decoding;

means for providing the reference index associated with the selected prediction reference candidate in a syntax element at a slice level or at a higher level.

According to a sixteenth example there is provided an apparatus comprising:

means for determining a list of prediction reference candidates for a slice of a picture in one or more reference pictures;

means for associating each prediction reference candidate in the list with a reference index;

means for selecting one of the prediction reference candidates as a prediction reference in decoding the picture by examining the prediction reference candidates.

What is claimed is:

1. A method comprising:
determining a list of reference pictures being prediction reference candidates for a slice of a picture;
associating each prediction reference candidate in the list with a reference index;
obtaining a reference index associated with a selected prediction reference candidate for motion vector prediction at a slice level or at a higher level.

2. The method according to claim 1 comprising using the method in a merge coding mode.

3. The method according to claim 1 comprising performing a first examination to determine, if the prediction reference candidate associated with a first reference index is available for motion vector prediction for the slice;
if the first examination indicates that the prediction reference candidate with the first reference index is not available for motion vector prediction for the slice, performing a second examination to determine if the list comprises another prediction reference candidate associated with another reference index;
if the second examination indicates that the list comprises another prediction reference candidate associated with the another reference index, determining, if the prediction reference candidate associated with the another reference index is available for motion vector prediction for the slice;
if the determination indicates that the prediction reference candidate associated with the another reference index is available, using the reference index associated with the other prediction reference candidate as the reference index associated with the selected prediction reference candidate.

4. The method according to claim 3 comprising determining, if the prediction reference candidate is available for motion vector prediction on the basis of at least one of the following:
the prediction reference candidate is a long term reference picture;
the prediction reference candidate belongs to a same layer as the slice;
the prediction reference candidate belongs to a same view as the slice;
a type of the prediction reference candidate;
a picture order count;
a coding mode.

5. The method according to claim 1 comprising obtaining a picture order count for the slice; and comparing the picture order count of the slice with a picture order count of a reference picture, and if the comparison indicates that the picture order count of the slice is equal to the picture order count of the reference picture, determining that the reference picture is not available for motion vector prediction for the slice.

6. The method according to claim 1 comprising encoding an uncompressed picture into a coded picture comprising the slice.

7. The method according to claim 1 comprising decoding a coded picture comprising the slice into a decoded picture.

8. An apparatus comprising at least one processor and at least one memory including computer program code, the at least one memory and the computer program code configured to, with the at least one processor, cause the apparatus to:
determine a list of reference pictures being prediction reference candidates for a slice of a picture;
associate each prediction reference candidate in the list with a reference index;
obtaining a reference index associated with a prediction reference candidate for motion vector prediction at a slice level or at a higher level.

9. The apparatus according to claim 8, said at least one memory stored with code thereon, which when executed by said at least one processor, further causes the apparatus to use the method in a merge coding mode.

10. The apparatus according to claim 8, said at least one memory stored with code thereon, which when executed by said at least one processor, further causes the apparatus to perform a first examination to determine, if the prediction reference candidate associated with a first reference index is available for motion vector prediction for the slice;
if the first examination indicates that the prediction reference candidate with the first reference index is not available for motion vector prediction for the slice, to perform a second examination to determine if the list comprises another prediction reference candidate associated with another reference index;
if the second examination indicates that the list comprises another prediction reference candidate associated with the another reference index, to determine, if the prediction reference candidate associated with the another reference index is available for motion vector prediction for the slice;
if the determination indicates that the prediction reference candidate associated with the another reference index is available, to use the reference index associated with the other prediction reference candidate as the reference index associated with the selected prediction reference candidate.

11. The apparatus according to claim 10, said at least one memory stored with code thereon, which when executed by said at least one processor, further causes the apparatus to determine, if the prediction reference candidate is available for motion vector prediction on the basis of at least one of the following:
the prediction reference candidate is a long term reference picture;
the prediction reference candidate belongs to a same layer as the slice;
the prediction reference candidate belongs to a same view as the slice;
a type of the prediction reference candidate;
a picture order count;
a coding mode.

12. The apparatus according to claim 8, said at least one memory stored with code thereon, which when executed by said at least one processor, further causes the apparatus to obtain a picture order count for the slice; and to compare the picture order count of the slice with a picture order count of a reference picture, and if the comparison indicates that the picture order count of the slice is equal to the picture order count of the reference picture, to determine that the reference picture is not available for motion vector prediction for the slice.

13. The apparatus according to claim 8, said at least one memory stored with code thereon, which when executed by said at least one processor, further causes the apparatus to decode a coded picture comprising the slice into a decoded picture.

14. A computer program product including one or more sequences of one or more instructions which, when executed by one or more processors, cause an apparatus to at least perform the following:
determine a list of reference pictures being prediction reference candidates for a slice of a picture;
associate each prediction reference candidate in the list with a reference index;
obtain a reference index associated with a prediction reference candidate for motion vector prediction at a slice level or at a higher level.

15. The computer program product according to claim 14 including one or more sequences of one or more instructions which, when executed by one or more processors, cause the apparatus to use the method in a merge coding mode.

16. The computer program product according to claim 14 including one or more sequences of one or more instructions which, when executed by one or more processors, cause the apparatus to perform a first examination to determine, if the prediction reference candidate associated with a first reference index is available for motion vector prediction for the slice;
if the first examination indicates that the prediction reference candidate with the first reference index is not available for motion vector prediction for the slice, to perform a second examination to determine if the list comprises another prediction reference candidate associated with another reference index;
if the second examination indicates that the list comprises another prediction reference candidate associated with the another reference index, to determine, if the prediction reference candidate associated with the another reference index is available for motion vector prediction for the slice;
if the determination indicates that the prediction reference candidate associated with the another reference index is available, to use the reference index associated with the other prediction reference candidate as the reference index associated with the selected prediction reference candidate.

17. The computer program product according to claim 16 including one or more sequences of one or more instructions which, when executed by one or more processors, cause the apparatus to determine, if the prediction reference candidate is available for motion vector prediction on the basis of at least one of the following:
the prediction reference candidate is a long term reference picture;
the prediction reference candidate belongs to a same layer as the slice;
the prediction reference candidate belongs to a same view as the slice;
a type of the prediction reference candidate;
a picture order count;
a coding mode.

18. The computer program product according to claim 14 including one or more sequences of one or more instructions which, when executed by one or more processors, cause the apparatus to obtain a picture order count for the slice; and to compare the picture order count of the slice with a picture order count of a reference picture, and if the comparison indicates that the picture order count of the slice is equal to the picture order count of the reference picture, to determine that the reference picture is not available for motion vector prediction for the slice.

19. The computer program product according to claim 14 including one or more sequences of one or more instructions which, when executed by one or more processors, cause the apparatus to encode an uncompressed picture into a coded picture comprising the slice.

20. The computer program product according to claim 14 including one or more sequences of one or more instructions which, when executed by one or more processors, cause the apparatus to decode a coded picture comprising the slice into a decoded picture.
